(19) United States
(12) Patent Application Publication
(10) Pub. No.: US 2025/0260163 A1
(43) Pub. Date: Aug. 14, 2025

(54) Wireless Network Device Operable in the 6 GHz Bandwidth

(71) Applicant: Google LLC, Mountain View, CA (US)

(72) Inventors: Yau-Shing Lee, Sunnyvale, CA (US); Daniel Pacifico, Fairfield, CA (US); Yiwen Wu, Mountain View, CA (US); Alejandro Pinto, Dublin, CA (US); Che-Wei Liu, New Taipei City (TW); Frédéric Heckmann, Taipei City (TW); Chia-Yang Chang, Taipei City (TW); Marc Stuart Specter Davidson, Sunnyvale, CA (US); Adrian Cooke, San Mateo, CA (US)

(73) Assignee: Google LLC, Mountain View, CA (US)

(21) Appl. No.: 18/881,935

(22) PCT Filed: Aug. 16, 2022
(86) PCT No.: PCT/US2022/075031

§ 371 Date: Jan. 7, 2025

(51) Int. Cl. H01Q 5/20; H01Q 1/00; H01Q 1/42; H01Q 1/52

(52) U.S. Cl. CPC H01Q 5/20; H01Q 1/002; H01Q 1/526; H01Q 1/42

(57) ABSTRACT

The present document describes a wireless local area network (WLAN) device operable in the 6 gigahertz (GHz) band, in addition to 2.4 GHz and 5 GHz bands. The device includes a small form factor having a housing enclosing a tri-axis antenna system with three pairs of antennas oriented along orthogonal principle axes [x, y, z]. The device also has multiple heat sinks, which act as a shielding device for opposing sides of a circuit board assembly. An antenna plate covers openings of cavities defined by the heat sinks. Antenna patterns are decorrelated based on oppositely directed radiation patterns. Also, the 2.4 GHz antennas are attached to the circuit board assembly, extend outwardly from the heat sinks, and are offset from a base of the device by a distance of at least a one quarter wavelength to minimize effects from a surface upon which the device rests.

### BACKGROUND

Wi-Fi devices can be large and visually unappealing due to hardware constraints. Some of these devices include external antennas that, based on the device's location within a user's home, are within reach of small children or animals that may move or damage the antennas. Wi-Fi devices can include complex controls and status lights that can be difficult for some users to understand. These aspects of conventional range-extender devices can frustrate users and diminish their user experience.

### SUMMARY

The present document describes a wireless network device operable in the 6 gigahertz (GHz) frequency band, in addition to 2.4 GHz and 5 GHz frequency bands. The device includes a small form factor having a housing enclosing a tri-axis antenna system with three pairs of antennas oriented along orthogonal principle axes [x, y, z]. The device also has multiple heat sinks, which act as a shielding device for opposing sides (e.g., surfaces populated with integrated circuit components) of a circuit board assembly. An antenna plate covers openings of cavities defined by the heat sinks. Antenna patterns are decorrelated based on oppositely directed radiation patterns. Also, the 2.4 GHz antennas are attached to the circuit board assembly, extend outwardly from the heat sinks, and are offset from a base of the device by a distance of at least a one quarter wavelength to minimize effects from a surface upon which the device rests.

In aspects a wireless network device includes a housing having a height along a y-axis, a width along an x-axis, and a depth along a z-axis. In some implementations, the height is greater than the width and the width is greater than the depth. In some implementations, the housing forms an upright rectangular cuboid with rounded corners and edges. In some implementations, the housing includes a front housing component and a rear housing component that connect to each other along a perimeter of each of the front and rear housing components along an xy-plane defined by the x-axis and the y-axis. In some implementations, the wireless network device also include an antenna system enclosed within the housing and operable in at least three bands including 2.4 gigahertz, 5 gigahertz, and 6 gigahertz. In some implementations, the wireless network device also includes a circuit board assembly positioned within the housing and operable to provide at least one of a gateway or a node to a wireless network.

In some implementations the circuit board assembly is supported in an orientation parallel to the xy-plane. In addition or as an alternative, in some implementations, the circuit board assembly is enclosed within an antenna-and-shielding subassembly comprising first and second heat sinks assembled together with the circuit board assembly therebetween to shield the antenna system from electromagnetic interference generated by electrical components on the circuit board assembly. In some of these implementations, the circuit board assembly includes a first side and an opposing second side, the first heat sink includes: a first inner surface that physically contacts the first side of the circuit board assembly to conduct heat away from the first side of the circuit board assembly; and a first outer surface that conformingly corresponds to a first interior surface of the front housing component and contacts the first interior surface of the front housing component to transfer heat to the front housing component. In some of these implementations, the second heat sink includes: a second inner surface that physically contacts the second side of the circuit board assembly to conduct heat away from the second side of the circuit board assembly; and a second outer surface that conformingly corresponds to a second interior surface of the rear housing component and contacts the second interior surface of the rear housing component to transfer heat to the rear housing component. In some of these implementations, the first and second heat sinks each define a cavity with an opening, and the antenna-and-shielding subassembly includes an antenna plate covering the opening of each cavity. In some of these implementations, the antenna system includes multiple antennas attached to the antenna plate and forming a 5-gigahertz wireless network system including both primary and diversity antenna switching. In some of these implementations, the antenna plate is a single piece of sheet metal forming a ground plane and the multiple antennas on the antenna plate are stamped and bent to be above the ground plane. In addition or as an alternative, in some implementations, the antenna system includes at least two antennas attached to the circuit board assembly that extend outwardly from an edge of the circuit board assembly, the at least two antennas are coplanar with the circuit board assembly, the at least two antennas extend outwardly from the first and second heat sinks that surround the circuit board assembly, and the at least two antennas are offset from a base of the wireless network device by approximately one quarter wavelength. In some of these implementations, the at least two antennas are attached to the circuit board assembly via a surface mount technology. In addition or as an alternative, in some implementations, the at least two antennas are each operable in both the 2.4 gigahertz band and the 6 gigahertz band. In addition or as an alternative, in some implementations, the at least two antennas are decorrelated based on a minimization of products of electrical fields generated by each of the at least two antennas and based on radiation patterns of the at least two antennas being directed in opposite directions relative to one another. In addition or as an alternative, in some implementations, the first and second heat sinks have a y-axis dimension that is in a range of 50% to 90% of the height of the housing.

In some implementations, the rear housing component includes one or more openings that align with one or more ports on the circuit board assembly, and the one or more openings are located in a portion of the rear housing component that is parallel to the xy-plane. In some of these implementations, the one or more ports on the circuit board assembly include an Ethernet port and an electrical power connector.

In some implementations, the antenna system is a tri-axis orthogonal antenna system having three pairs of antennas oriented along orthogonal principle axes.

This summary is provided to introduce simplified concepts of a wireless network device operable in the 6 GHz band, which are further described below in the Detailed Description. This summary is not intended to identify essential features of the claimed subject matter.

### BRIEF DESCRIPTION OF THE DRAWINGS

The details of one or more aspects of a wireless network device operable in the 6 GHz band are described in this document with reference to the following drawings. The same numbers are used throughout the drawings to reference like features and components:

FIG. 1A is an example network environment in which various aspects of a wireless network device operable in the 6 GHz band can be implemented;

FIG. 1B illustrates the example environment from FIG. 1 in more detail.

FIG. 2A illustrates an example home area network system in which various aspects of a wireless network device operable in the 6 GHz band can be implemented;

FIG. 2B illustrates an example operating environment in which a server system interacts with client devices and smart devices in accordance with some implementations;

FIG. 3 is a block diagram illustrating the server system in accordance with some implementations;

FIG. 4 is a block diagram illustrating an example smart device in accordance with some implementations;

FIG. 5 is a block diagram illustrating a representative client device associated with a user account in accordance with some implementations;

FIG. 6 illustrates an example wireless network device operable in the 6 GHz band in accordance with some implementations;

FIG. 7 illustrates an exploded view of the example apparatus in FIG. 6;

FIG. 8 illustrates some components of the device from FIG. 7, including a circuit board assembly and multiple heat sinks;

FIG. 9 illustrates a front left perspective view of a partially assembled version of an antenna-and-shielding subassembly of the device from FIG. 7;

FIG. 10 illustrates an example implementation of a fully assembled version of the antenna-and-shielding subassembly from FIG. 9; and

FIGS. 11A, 11B, 11C, and 11D illustrate example radiation patterns of the antennas (e.g., 2.4 GHz and 6 GHz antennas) from FIG. 7, in accordance with one or more implementations.

### DETAILED DESCRIPTION

The present document describes a wireless network device operable in the 6 GHz band. The device described herein has a small form factor and supports Wi-Fi 6E (a Wi-Fi Alliance standard for an extension of Wi-Fi 6 (IEEE 802.11ax)), which enables operation of features in the unlicensed 6 GHz band in addition to 2.4 GHz and 5 GHz bands. The device includes heat sinks that completely surround the circuit board assembly for both thermal and electrical purposes. Thermally, the heat sinks conduct heat from both sides of the circuit board assembly and electrically, the heat sinks form a full shielding box for the circuit board assembly. Accordingly, the heat sinks provide shielding for external interference (e.g., interference to external components caused by the circuit board assembly).

Thus, computing systems and devices are provided with more efficient methods for Wi-Fi 6E in a small form factor. These disclosed systems and devices thereby increase the effectiveness, efficiency, and user satisfaction with such systems and devices.

While features and concepts of the described techniques for a wireless network device operable in the 6 GHz band can be implemented in any number of different environments, aspects are described in the context of the following examples.

### Example Device

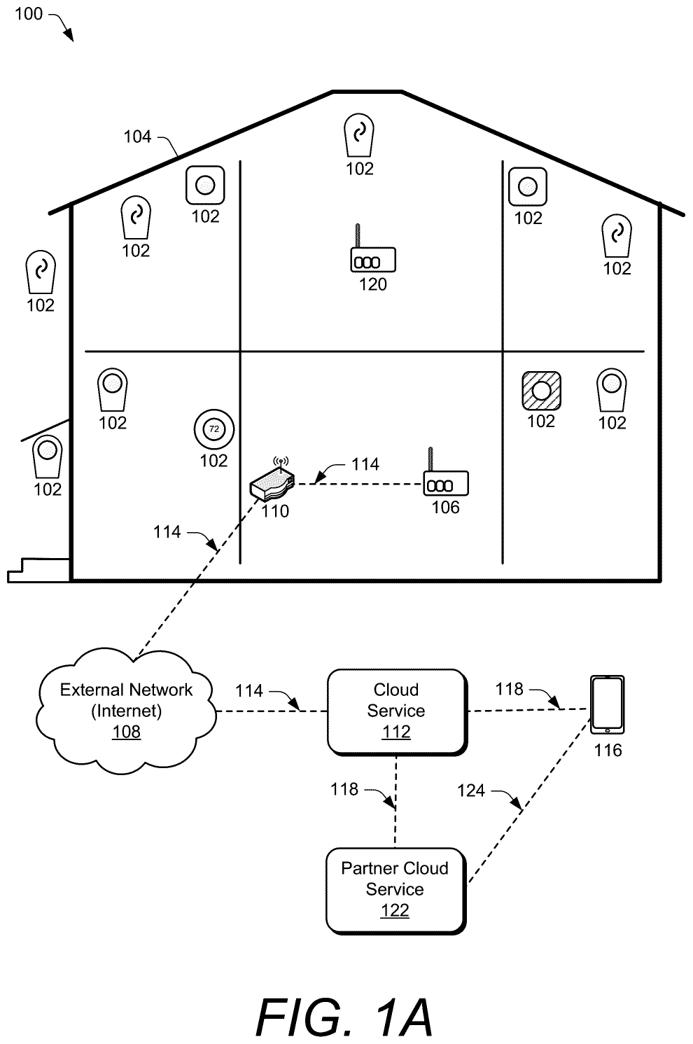

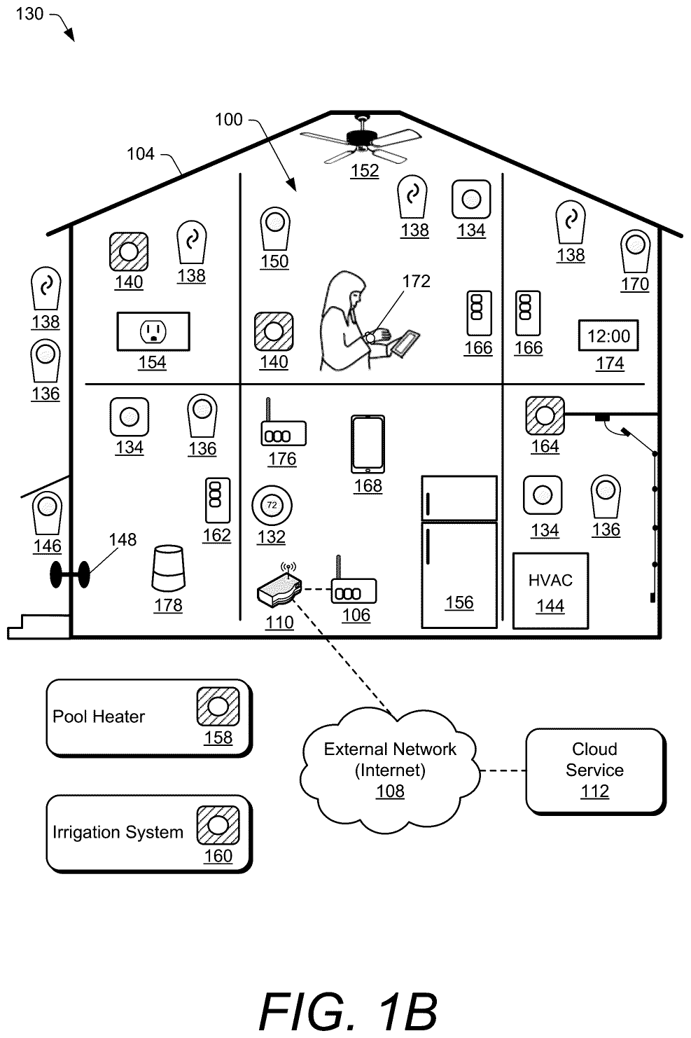

FIG. 1A illustrates an example network environment 100 (e.g., network environment) in which a wireless network device operable in the 6 GHz band can be implemented. The network environment 100 includes a home area network (HAN). The HAN includes wireless network devices 102 (e.g., electronic devices) that are disposed about a structure 104, such as a house, and are connected by one or more wireless and/or wired network technologies, as described below. The HAN includes a border router 106 that connects the HAN to an external network 108, such as the Internet, through a home router or access point 110.

To provide user access to functions implemented using the wireless network devices 102 in the HAN, a cloud service 112 connects to the HAN via a border router 106, via a secure tunnel 114 through the external network 108 and the access point 110. The cloud service 112 facilitates communication between the HAN and internet clients 116, such as apps on mobile devices, using a web-based application programming interface (API) 118. The cloud service 112 also manages a home graph that describes connections and relationships between the wireless network devices 102, elements of the structure 104, and users. The cloud service 112 hosts controllers, which orchestrate and arbitrate home automation experiences, as described in greater detail below.

The HAN may include one or more wireless network devices 102 that function as a hub 120. The hub 120 may be a general-purpose home automation hub, or an application-specific hub, such as a security hub, an energy-management hub, a Heating, Ventilation, and Air Conditioning (HVAC) hub, and so forth. The functionality of a hub 120 may also be integrated into any wireless network device 102, such as a smart thermostat device or the border router 106. In addition to hosting controllers on the cloud service 112, controllers can be hosted on any hub 120 in the structure 104, such as the border router 106. A controller hosted on the cloud service 112 can be moved dynamically to the hub 120 in the structure 104, such as moving an HVAC zone controller to a newly installed smart thermostat.

Hosting functionality on the hub 120 in the structure 104 can improve reliability when the user's internet connection is unreliable, can reduce latency of operations that would normally have to connect to the cloud service 112, and can satisfy system and regulatory constraints around local access between wireless network devices 102.

The wireless network devices 102 in the HAN may be from a single manufacturer that provides the cloud service 112 as well, or the HAN may include wireless network devices 102 from partners. These partners may also provide partner cloud services 122 that provide services related to their wireless network devices 102 through a partner Web API 124. The partner cloud service 122 may optionally or additionally provide services to internet clients 116 via the web-based API 118, the cloud service 112, and the secure tunnel 114.

The network environment 100 can be implemented on a variety of hosts, such as battery-powered microcontroller-based devices, line-powered devices, and servers that host cloud services. Protocols operating in the wireless network devices 102 and the cloud service 112 provide a number of services that support operations of home automation experiences in the distributed computing environment 100. These services include, but are not limited to, real-time distributed data management and subscriptions, command-and-response control, real-time event notification, historical data logging and preservation, cryptographically controlled security groups, time synchronization, network and service pairing, and software updates.

FIG. 1B illustrates an example environment 130 in which a home area network, as described with reference to FIG. 1A, and aspects of a wireless network device operable in the 6 GHz band can be implemented. Generally, the environment 130 includes the home area network (HAN) implemented as part of a home or other type of structure with any number of wireless network devices (e.g., wireless network devices 102) that are configured for communication in a wireless network. For example, the wireless network devices can include a thermostat 132, hazard detectors 134 (e.g., for smoke and/or carbon monoxide), cameras 136 (e.g., indoor and outdoor), lighting units 138 (e.g., indoor and outdoor), and any other types of wireless network devices 140 that are implemented inside and/or outside of a structure 104 (e.g., in a home environment). In this example, the wireless network devices can also include any of the previously described devices, such as a border router 106, as well as the wireless network device 102.

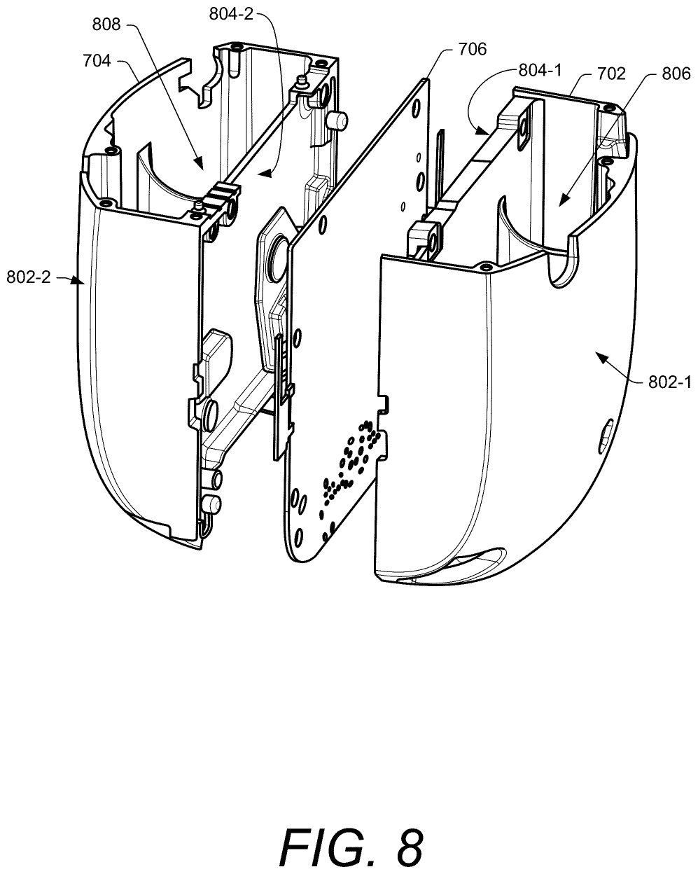

In the environment 130, any number of the wireless network devices can be implemented for wireless interconnection to wirelessly communicate and interact with each other. The wireless network devices are modular, intelligent, multi-sensing, network-connected devices that can integrate seamlessly with each other and/or with a central server or a cloud-computing system to provide any of a variety of useful automation objectives and implementations. An example of a wireless network device that can be implemented as any of the devices described herein is shown and described with reference to FIG. 8

In implementations, the thermostat 132 may include a Nest® Learning Thermostat that detects ambient climate characteristics (e.g., temperature and/or humidity) and controls an HVAC system 144 in the home environment. The learning thermostat 132 and other network-connected devices “learn” by capturing occupant settings to the devices. For example, the thermostat learns preferred temperature set points for mornings and evenings, and when the occupants of the structure are asleep or awake, as well as when the occupants are typically away or at home.

A hazard detector 134 can be implemented to detect the presence of a hazardous substance or a substance indicative of a hazardous substance (e.g., smoke, fire, or carbon monoxide). In examples of wireless interconnection, a hazard detector 134 may detect the presence of smoke, indicating a fire in the structure, in which case the hazard detector that first detects the smoke can broadcast a low-power wake-up signal to all of the connected wireless network devices. The other hazard detectors 134 can then receive the broadcast wake-up signal and initiate a high-power state for hazard detection and to receive wireless communications of alert messages. Further, the lighting units 138 can receive the broadcast wake-up signal and activate in the region of the detected hazard to illuminate and identify the problem area. In another example, the lighting units 138 may activate in one illumination color to indicate a problem area or region in the structure, such as for a detected fire or break-in, and activate in a different illumination color to indicate safe regions and/or escape routes out of the structure.

In various configurations, the wireless network devices 140 can include an entryway interface device 146 that functions in coordination with a network-connected door lock system 148, and that detects and responds to a person's approach to or departure from a location, such as an outer door of the structure 104. The entryway interface device 146 can interact with the other wireless network devices based on whether someone has approached or entered the smart-home environment. An entryway interface device 146 can control doorbell functionality, announce the approach or departure of a person via audio or visual means, and control settings on a security system, such as to activate or deactivate the security system when occupants come and go. The wireless network devices 140 can also include other sensors and detectors, such as to detect ambient lighting conditions, detect room-occupancy states (e.g., with an occupancy sensor 150), and control a power and/or dim state of one or more lights. In some instances, the sensors and/or detectors may also control a power state or speed of a fan, such as a ceiling fan 152. Further, the sensors and/or detectors may detect occupancy in a room or enclosure and control the supply of power to electrical outlets or devices 154, such as if a room or the structure is unoccupied.

The wireless network devices 140 may also include connected appliances and/or controlled systems 156, such as refrigerators, stoves and ovens, washers, dryers, air conditioners, pool heaters 158, irrigation systems 160, security systems 162, and so forth, as well as other electronic and computing devices, such as televisions, entertainment systems, computers, intercom systems, garage-door openers 164, ceiling fans 152, control panels 166, and the like. When plugged in, an appliance, device, or system can announce itself to the home area network as described above and can be automatically integrated with the controls and devices of the home area network, such as in the home. It should be noted that the wireless network devices 140 may include devices physically located outside of the structure, but within wireless communication range, such as a device controlling a swimming pool heater 158 or an irrigation system 160.

As described above, the HAN includes a border router 106 that interfaces for communication with an external network, outside the HAN. The border router 106 connects to an access point 110, which connects to the external network 108, such as the Internet. A cloud service 112, which is connected via the external network 108, provides services related to and/or using the devices within the HAN. By way of example, the cloud service 112 can include applications for connecting end-user devices 168, such as smartphones, tablets, and the like, to devices in the home area network, processing and presenting data acquired in the HAN to end-users, linking devices in one or more HANs to user accounts of the cloud service 112, provisioning and updating devices in the HAN, and so forth. For example, a user can control the thermostat 132 and other wireless network devices in the home environment using a network-connected computer or portable device, such as a mobile phone or tablet device. Further, the wireless network devices can communicate information to any central server or cloud-computing system via the border router 106 and the access point 110. The data communications can be carried out using any of a variety of custom or standard wireless protocols (e.g., Wi-Fi, ZigBee for low power, 6LoWPAN, Thread, etc.) and/or by using any of a variety of custom or standard wired protocols (CAT6 Ethernet, HomePlug, and so on).

Any of the wireless network devices in the HAN can serve as low-power and communication nodes to create the HAN in the home environment. Individual low-power nodes of the network can regularly send out messages regarding what they are sensing, and the other low-powered nodes in the environment-in addition to sending out their own messages-can repeat the messages, thereby communicating the messages from node to node (e.g., from device to device) throughout the home area network. The wireless network devices can be implemented to conserve power, particularly when battery-powered, utilizing low-powered communication protocols to receive the messages, translate the messages to other communication protocols, and send the translated messages to other nodes and/or to a central server or cloud-computing system. For example, the occupancy sensor 150 and/or an ambient light sensor 170 can detect an occupant in a room as well as measure the ambient light, and activate the light source when the ambient light sensor 170 detects that the room is dark and when the occupancy sensor 150 detects that someone is in the room. Further, the sensor can include a low-power wireless communication chip (e.g., an IEEE 802.15.4 chip, a Thread chip, a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly, using the home area network, from node to node (e.g., network-connected device to network-connected device) within the home environment as well as over the Internet to a central server or cloud-computing system.

In other configurations, various ones of the wireless network devices can function as “tripwires” for an alarm system in the home environment. For example, in the event a perpetrator circumvents detection by alarm sensors located at windows, doors, and other entry points of the structure or environment, the alarm could still be triggered by receiving an occupancy, motion, heat, sound, etc. message from one or more of the low-powered mesh nodes in the home area network. In other implementations, the home area network can be used to automatically turn on and off the lighting units 138 as a person transitions from room to room in the structure. For example, the wireless network devices can detect the person's movement through the structure and communicate corresponding messages via the nodes of the home area network. Using the messages that indicate which rooms are occupied, other wireless network devices that receive the messages can activate and/or deactivate accordingly. As referred to above, the home area network can also be utilized to provide exit lighting in the event of an emergency, such as by turning on the appropriate lighting units 138 that lead to a safe exit. The light units 138 may also be turned on to indicate the direction along an exit route that a person should travel to safely exit the structure.

The various wireless network devices may also be implemented to integrate and communicate with wearable computing devices 172, such as may be used to identify and locate an occupant of the structure and adjust the temperature, lighting, sound system, and the like accordingly. In other implementations, radio frequency identification (RFID) sensing (e.g., a person having an RFID bracelet, necklace, or key fob), synthetic vision techniques (e.g., video cameras and face recognition processors), audio techniques (e.g., voice, sound pattern, vibration pattern recognition), ultrasound sensing/imaging techniques, and infrared (IR) or near-field communication (NFC) techniques (e.g., a person wearing an IR-or NFC-capable smartphone), along with rules-based inference engines or artificial intelligence techniques may draw useful conclusions from the sensed information as to the location of an occupant in the structure or environment.

In other implementations, personal comfort-area networks, personal health-area networks, personal safety-area networks, and/or other such human-facing functionalities of service robots can be enhanced by logical integration with other wireless network devices and sensors in the environment according to rules-based inferencing techniques or artificial intelligence techniques for achieving better performance of these functionalities. In an example relating to a personal health area, the system can detect whether a household pet is moving toward the current location of an occupant (e.g., using any of the wireless network devices and sensors), along with rules-based inferencing and artificial intelligence techniques. Similarly, a hazard detector service robot can be notified that the temperature and humidity levels are rising in a kitchen, and temporarily raise a hazard detection threshold, such as a smoke detection threshold, under an inference that any small increases in ambient smoke levels will most likely be due to cooking activity and not due to a genuinely hazardous condition. Any service robot that is configured for any type of monitoring, detecting, and/or servicing can be implemented as a mesh node device on the home area network, conforming to the wireless interconnection protocols for communicating on the home area network.

The wireless network devices 140 may also include a network-connected alarm clock 174 for each of the individual occupants of the structure in the home environment. For example, an occupant can customize and set an alarm device for a wake time, such as for the next day or week. Artificial intelligence can be used to consider occupant responses to the alarms when they go off and make inferences about preferred sleep patterns over time. An individual occupant can then be tracked in the home area network based on a unique signature of the person, which is determined based on data obtained from sensors located in the wireless network devices, such as sensors that include ultrasonic sensors, passive infrared (PIR) sensors, and the like. The unique signature of an occupant can be based on a combination of patterns of movement, voice, height, size, etc., as well as using facial recognition techniques.

In an example of wireless interconnection, the wake time for an individual can be associated with the thermostat 132 to control the HVAC system in an efficient manner so as to pre-heat or cool the structure to desired sleeping and awake temperature settings. The preferred settings can be learned over time, such as by capturing the temperatures set in the thermostat before the person goes to sleep and upon waking up. Collected data may also include biometric indications of a person, such as breathing patterns, heart rate, movement, etc., from which inferences are made based on this data in combination with data that indicates when the person actually wakes up. Other wireless network devices can use the data to provide other automation objectives, such as adjusting the thermostat 132 so as to pre-heat or cool the environment to a desired setting and turning on or turning off the lighting units 138.

In implementations, the wireless network devices can also be utilized for sound, vibration, and/or motion sensing such as to detect running water and determine inferences about water usage in a home environment based on algorithms and mapping of the water usage and consumption. This can be used to determine a signature or fingerprint of each water source in the home and is also referred to as “audio fingerprinting water usage.” Similarly, the wireless network devices can be utilized to detect the subtle sound, vibration, and/or motion of unwanted pests, such as mice and other rodents, as well as by termites, cockroaches, and other insects. The system can then notify an occupant of the suspected pests in the environment, such as with warning messages to help facilitate early detection and prevention.

The environment 130 may include one or more wireless network devices that function as a hub 176. The hub 176 (e.g., hub 120) may be a general-purpose home automation hub, or an application-specific hub, such as a security hub, an energy management hub, an HVAC hub, and so forth. The functionality of a hub 176 may also be integrated into any wireless network device, such as a network-connected thermostat device or the border router 106. Hosting functionality on the hub 176 in the structure 104 can improve reliability when the user's internet connection is unreliable, can reduce latency of operations that would normally have to connect to the cloud service 112, and can satisfy system and regulatory constraints around local access between wireless network devices.

Additionally, the example environment 130 includes a network-connected-speaker 178. The network-connected speaker 178 provides voice assistant services that include providing voice control of network-connected devices. The functions of the hub 176 may be hosted in the network-connected speaker 178. The network-connected speaker 178 can be configured to communicate via the HAN, which may include a wireless mesh network, a Wi-Fi network, or both.

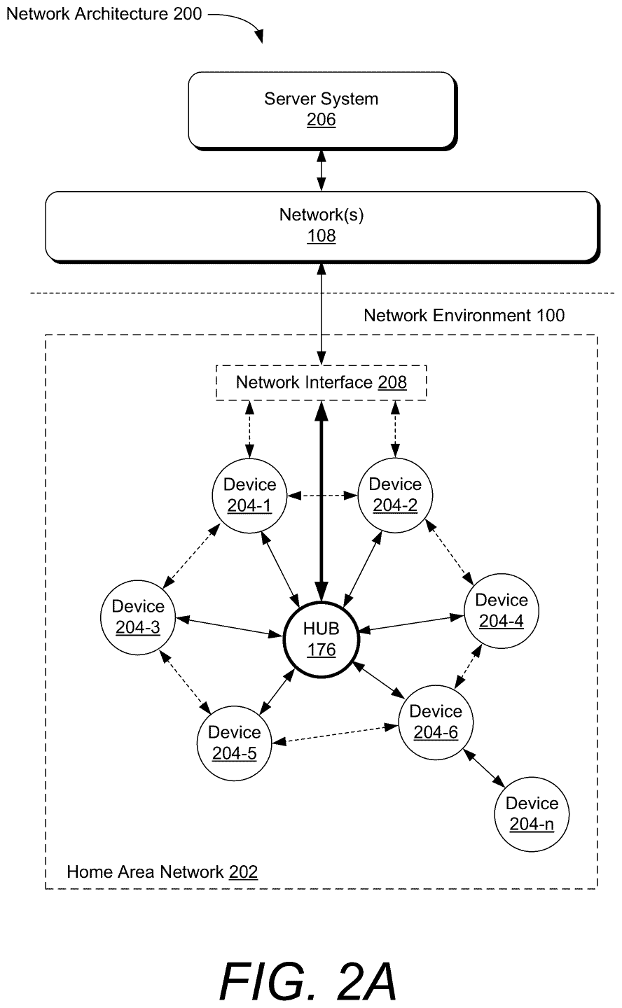

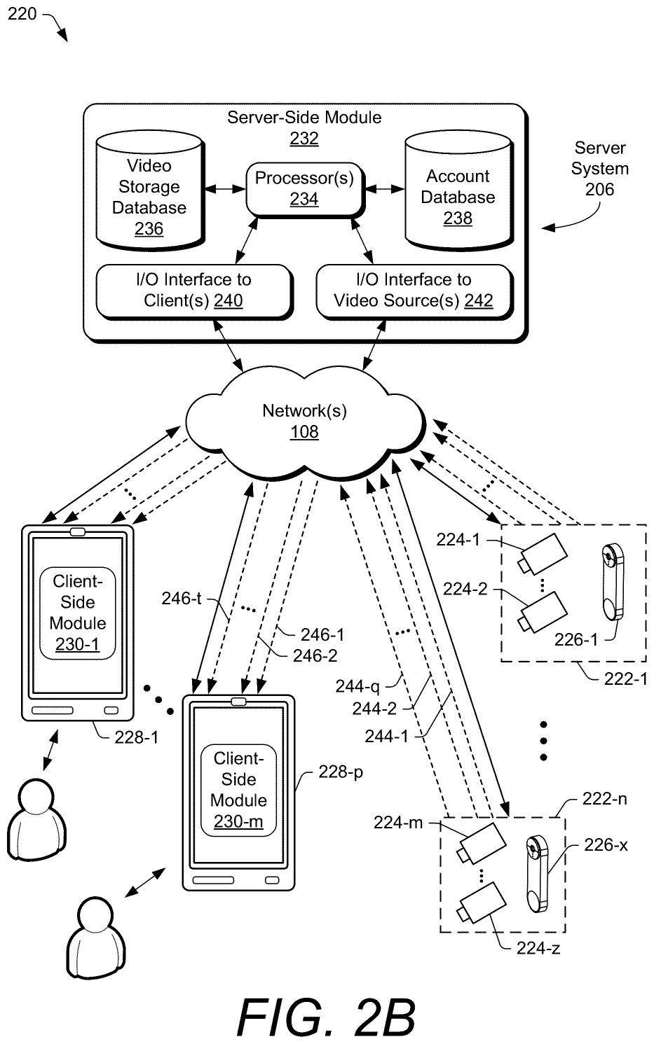

FIG. 2A is a block diagram illustrating a representative network architecture 200 that includes a home area network 202 (HAN 202) in accordance with some implementations. In some implementations, smart devices 204 (e.g., wireless network devices 102) in the network environment 100 combine with the hub 176 to create a mesh network in the HAN 202. In some implementations, one or more of the smart devices 204 in the HAN 202 operate as a smart home controller. Additionally and/or alternatively, the hub 176 may operate as the smart home controller. In some implementations, a smart home controller has more computing power than other smart devices. The smart home controller can process inputs (e.g., from smart devices 204, end user devices 168, and/or server system 206) and send commands (e.g., to smart devices 204 in the HAN 202) to control operation of the network environment 100. In aspects, some of the smart devices 204 in the HAN 202 (e.g., in the mesh network) are “spokesman” nodes (e.g., 204-1, 204-2, 204-3, 204-4, 204-5, 204-6) and others are “low-powered” nodes (e.g., 204-n). Some of the smart devices in the network environment 100 may be battery-powered, while others may have a regular and reliable power source, such as via line power (e.g., to 120V line voltage wires). The smart devices that have a regular and reliable power source are referred to as “spokesman” nodes. These nodes are typically equipped with the capability of using a wireless protocol to facilitate bidirectional communication with a variety of other devices in the network environment 100, as well as with the server system 206 (e.g., cloud service 112, partner cloud service 122). In some implementations, one or more “spokesman” nodes operate as a smart home controller. On the other hand, the devices that are battery-powered are the “low-power” nodes. These nodes tend to be smaller than spokesman nodes and typically only communicate using wireless protocols that require very little power, such as Zigbee, Z-Wave, 6LoWPAN, Thread, Bluetooth, etc.

Some low-power nodes may be incapable of bidirectional communication. These low-power nodes send messages but are unable to “listen”. Thus, other devices in the network environment 100, such as the spokesman nodes, cannot send information to these low-power nodes.

Some low-power nodes may be capable of only a limited bidirectional communication. As a result of such limited bidirectional communication, other devices may be able to communicate with these low-power nodes only during a certain time period.

As described, in some implementations, the smart devices serve as low-power and spokesman nodes to create a mesh network in the network environment 100. In some implementations, individual low-power nodes in the network environment regularly send out messages regarding what they are sensing, and the other low-powered nodes in the network environment-in addition to sending out their own messages-forward the messages, thereby causing the messages to travel from node to node (e.g., device to device) throughout the HAN 202. In some implementations, the spokesman nodes in the HAN 202, which are able to communicate using a relatively high-power communication protocol (e.g., IEEE 802.11), are able to switch to a relatively low-power communication protocol (e.g., IEEE 802.15.4) to receive these messages, translate the messages to other communication protocols, and send the translated messages to other spokesman nodes and/or the server system 206 (using, e.g., the relatively high-power communication protocol). Thus, the low-powered nodes using low-power communication protocols are able to send and/or receive messages across the entire HAN 202, as well as over the Internet (e.g., network 108) to the server system 206. In some implementations, the mesh network enables the server system 206 to regularly receive data from most or all of the smart devices in the home, make inferences based on the data, facilitate state synchronization across devices within and outside of the HAN 202, and send commands to one or more of the smart devices to perform tasks in the network environment.

As described, the spokesman nodes and some of the low-powered nodes are capable of “listening.” Accordingly, users, other devices, and/or the server system 206 may communicate control commands to the low-powered nodes. For example, a user may use the end user device 168 (e.g., a smart phone) to send commands over the Internet to the server system 206, which then relays the commands to one or more spokesman nodes in the HAN 202. The spokesman nodes may use a low-power protocol to communicate the commands to the low-power nodes throughout the HAN 202, as well as to other spokesman nodes that did not receive the commands directly from the server system 206.

In some implementations, a lighting unit 138 (FIG. 1B), which is an example of a smart device 204, may be a low-power node. In addition to housing a light source, the lighting unit 138 may house an occupancy sensor (e.g., occupancy sensor 150), such as an ultrasonic or passive IR sensor, and an ambient light sensor (e.g., ambient light sensor 170), such as a photo resistor or a single-pixel sensor that measures light in the room. In some implementations, the lighting unit 138 is configured to activate the light source when its ambient light sensor detects that the room is dark and when its occupancy sensor detects that someone is in the room. In other implementations, the lighting unit 138 is simply configured to activate the light source when its ambient light sensor detects that the room is dark. Further, in some implementations, the lighting unit 138 includes a low-power wireless communication chip (e.g., a ZigBee chip) that regularly sends out messages regarding the occupancy of the room and the amount of light in the room, including instantaneous messages coincident with the occupancy sensor detecting the presence of a person in the room. As mentioned above, these messages may be sent wirelessly (e.g., using the mesh network) from node to node (e.g., smart device to smart device) within the HAN 202 as well as over the Internet (e.g., network 108) to the server system 206.

Other examples of low-power nodes include battery-operated versions of the hazard detectors 134. These hazard detectors 134 are often located in an area without access to constant and reliable power and may include any number and type of sensors, such as smoke/fire/heat sensors (e.g., thermal radiation sensors), carbon monoxide/dioxide sensors, occupancy/motion sensors, ambient light sensors, ambient temperature sensors, humidity sensors, and the like. Furthermore, hazard detectors 134 may send messages that correspond to each of the respective sensors to the other devices and/or the server system 206, such as by using the mesh network as described above.

Examples of spokesman nodes include entryway interface devices 146 (e.g., smart doorbells), thermostats 132, control panels 166, electrical outlets or devices 154, and other wireless network devices 140. These devices are often located near and connected to a reliable power source, and therefore may include more power-consuming components, such as one or more communication chips capable of bidirectional communication in a variety of protocols.

In some implementations, the network environment 100 includes controlled systems 156, such as service robots, that are configured to carry out, in an autonomous manner, any of a variety of household tasks.

As explained with reference to FIG. 1B, in some implementations, the network environment 100 includes a hub device (e.g., hub 176) that is communicatively coupled to the network(s) 108 directly or via a network interface 208 (e.g., access point 110). The hub 176 is further communicatively coupled to one or more of the smart devices 204 using a radio communication network that is available at least in the network environment 100. Communication protocols used by the radio communication network include, but are not limited to, ZigBee, Z Wave, Insteon, EuOcean, Thread, OSIAN, Bluetooth Low Energy, and the like. In some implementations, the hub 176 not only converts the data received from each smart device to meet the data format requirements of the network interface 208 or the network(s) 108, but also converts information received from the network interface 208 or the network(s) 108 to meet the data format requirements of the respective communication protocol associated with a targeted smart device. In some implementations, in addition to data format conversion, the hub 176 further processes the data received from the smart devices or information received from the network interface 208 or the network(s) 108 preliminary. For example, the hub 176 can integrate inputs from multiple sensors/connected devices (including sensors/devices of the same and/or different types), perform higher-level processing on those inputs—e.g., to assess the overall environment and coordinate operation among the different sensors/devices—and/or provide instructions to the different devices based on the collection of inputs and programmed processing. It is also noted that in some implementations, the network interface 208 and the hub 176 are integrated into one network device. Functionality described herein is representative of particular implementations of smart devices, control application(s) running on representative electronic device(s) (such as a smart phone), hub(s) 176, and server system(s) 206 coupled to hub(s) 176 via the Internet or other Wide Area Network. All or a portion of this functionality and associated operations can be performed by any elements of the described system-for example, all or a portion of the functionality described herein as being performed by an implementation of the hub can be performed, in different system implementations, in whole or in part on the server, one or more connected smart devices and/or the control application, or different combinations thereof.

FIG. 2B illustrates a representative operating environment 220 in which a server system 206 provides data processing for monitoring and facilitating review of events (e.g., motion, audio, security, etc.) in video streams captured by cameras 136 (e.g., video cameras, doorbell cameras). As shown in FIG. 2B, the server system 206 receives video data from video sources 222 (including video cameras 224 or video-recording doorbells 226) located at various physical locations (e.g., inside or in proximity to homes, restaurants, stores, streets, parking lots, and/or the network environments 100 and 130 of FIGS. 1A and 1B). Each video source 222 may be linked to one or more reviewer accounts, and the server system 206 provides video monitoring data for the video source 222 to client devices 228 associated with the reviewer accounts. For example, the portable end user device 168 is an example of the client device 228. In some implementations, the server system 206 is a video processing server that provides video processing services to the video sources and client devices 228.

In some implementations, the server system 206 receives non-video data from one or more smart devices 204 (e.g., audio data, metadata, numerical data, etc.). The non-video data may be analyzed to provide context for motion events detected by the video cameras 224 and/or the video-recording doorbells 226. In some implementations, the non-video data indicates that an audio event (e.g., detected by an audio device such as an audio sensor integrated into the network-connected speaker 178), a security event (e.g., detected by a perimeter monitoring device such as the camera 136 and/or a motion sensor), a hazard event (e.g., detected by the hazard detector 134), medical event (e.g., detected by a health-monitoring device), or the like has occurred within a network environment 100.

In some implementations, multiple reviewer accounts are linked to a single network environment 100. For example, multiple occupants of a network environment 100 may have accounts linked to the network environment 100. In some implementations, each reviewer account is associated with a particular level of access. In some implementations, each reviewer account has personalized notification settings. In some implementations, a single reviewer account is linked to multiple network environments 100 (e.g., multiple different HANs). For example, a person may own or occupy, or be assigned to review and/or govern, multiple network environments 100. In some implementations, the reviewer account has distinct levels of access and/or notification settings for each network environment.

In some implementations, each of the video sources 222 includes one or more video cameras 224 or one or more video-recording doorbells 226 that capture video and send the captured video to the server system 206 substantially in real-time (e.g., within 1 second, 10 seconds, 30 seconds, or 1 minute). In aspects, a video source 222 includes a controller device (not shown) that serves as an intermediary between the one or more doorbells 226 and the server system 206. The controller device receives the video data from the one or more doorbells 226, optionally performs some preliminary processing on the video data, and sends the video data and/or the results of the preliminary processing to the server system 206 on behalf of the one or more doorbells 226 (e.g., in real-time). In some implementations, each camera has its own on-board processing capabilities to perform some preliminary processing on the captured video data before sending the video data (e.g., along with metadata obtained through the preliminary processing) to the controller device and/or the server system 206. In some implementations, one or more of the cameras is configured to, optionally, locally store the video data (e.g., for later transmission if requested by a user). In some implementations, a camera is configured to perform some processing of the captured video data and, based on the processing, either send the video data in substantially real-time, store the video data locally, or disregard the video data.

In accordance with some implementations, a client device 228 includes a client-side module 230. In some implementations, the client-side module communicates with a server-side module 232 executed on the server system 206 through the one or more networks 108. The client-side module provides client-side functionality for the event monitoring and review processing and communications with the server-side module. The server-side module provides server-side functionality for event monitoring and review processing for any number of client-side modules each residing on a respective client device 228 (e.g., any one of client devices 228-1 to 228-m). In some implementations, the server-side module 232 also provides server-side functionality for video processing and camera control for any number of the video sources 222, including any number of control devices, cameras 224, and doorbells 226.

In some implementations, the server system 206 includes one or more processors 234, a video storage database 236, an account database 238, an input/output (I/O) interface 240 to one or more client devices 228, and an I/O interface 242 to one or more video sources 222. The I/O interface 242 to one or more client devices 228 facilitates the client-facing input and output processing. The account database 238 stores a plurality of profiles for reviewer accounts registered with the video processing server, where a respective user profile includes account credentials for a respective reviewer account, and one or more video sources linked to the respective reviewer account. The I/O interface 242 to one or more video sources 222 facilitates communications with one or more video sources 222 (e.g., groups of one or more doorbells 226, cameras 224, and associated controller devices). The video storage database 236 stores raw video data received from the video sources 222, as well as various types of metadata, such as motion events, event categories, event categorization models, event filters, and event masks, for use in data processing for event monitoring and review for each reviewer account.

Examples of a representative client device 228 include a handheld computer, a wearable computing device, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, a point-of-sale (POS) terminal, a vehicle-mounted computer, an eBook reader, or a combination of any two or more of these data processing devices or other data processing devices.

Examples of the one or more networks 108 include local area networks (LAN) and wide area networks (WAN) such as the Internet. The one or more networks 108 are implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, Voice over Internet Protocol (VOIP), Wi-MAX, or any other suitable communication protocol.

In some implementations, the server system 206 is implemented on one or more standalone data processing apparatuses or a distributed network of computers. The server system 206 may also employ various virtual devices and/or services of third-party service providers (e.g., third-party cloud service providers) to provide the underlying computing resources and/or infrastructure resources of the server system 206. In some implementations, the server system 206 includes, but is not limited to, a server computer, a handheld computer, a tablet computer, a laptop computer, a desktop computer, or a combination of any two or more of these data processing devices or other data processing devices.

The server-client environment shown in FIG. 2B includes both a client-side portion (e.g., the client-side module) and a server-side portion (e.g., the server-side module). The division of functionality between the client and server portions of the operating environment can vary in different implementations. Similarly, the division of functionality between a video source 222 and the server system 206 can vary in different implementations. For example, in some implementations, the client-side module is a thin client that provides only user-facing input and output processing functions, and delegates all other data processing functionality to a backend server (e.g., the server system 206). Similarly, in some implementations, a respective one of the video sources 222 is a simple video capturing device that continuously captures and streams video data to the server system 206 with limited or no local preliminary processing on the video data. Although many aspects of the present technology are described from the perspective of the server system 206, the corresponding actions performed by a client device 228 and/or the video sources 222 would be apparent to one of skill in the art. Similarly, some aspects of the present technology may be described from the perspective of a client device or a video source, and the corresponding actions performed by the video server would be apparent to one of skill in the art. Furthermore, some aspects of the present technology may be performed by the server system 206, a client device 228, and a video source 222 cooperatively.

In some aspects, a video source 222 (e.g., a video camera 224 or a doorbell 226 having an image sensor) transmits one or more streams 244 of video data to the server system 206. For example, video source 222-1 may include one or more video cameras (e.g., 224-1, 224-2) and/or doorbell 226-1). Additionally or alternatively, video source 222-n may include one or more video cameras (e.g., 224-m through 224-z) and/or doorbell 226-x). In some implementations, the one or more streams include multiple streams, having respective resolutions and/or frame rates, of the raw video captured by the image sensor. In some implementations, the multiple streams include a “primary” stream (e.g., 244-1) with a certain resolution and frame rate, corresponding to the raw video captured by the image sensor, and one or more additional streams (e.g., 244-2 through 244-q). An additional stream is optionally the same video stream as the “primary” stream but at a different resolution and/or frame rate, or a stream that captures a portion of the “primary” stream (e.g., cropped to include a portion of the field of view or pixels of the primary stream) at the same or different resolution and/or frame rate as the “primary” stream. In some implementations, the primary stream and/or the additional streams are dynamically encoded (e.g., based on network conditions, server operating conditions, camera operating conditions, characterization of data in the stream (e.g., whether motion is present), user preferences, and the like.

In some implementations, one or more of the streams 244 is sent from the video source 222 directly to a client device 228 (e.g., without being routed to, or processed by, the server system 206). In some implementations, one or more of the streams is stored at a local memory of the doorbell 226 and/or at a local storage device (e.g., a dedicated recording device), such as a digital video recorder (DVR). For example, in accordance with some implementations, the doorbell 226 stores the most-recent 24 hours of video footage recorded by the camera. In some implementations, portions of the one or more streams are stored at the doorbell 226 and/or the local storage device (e.g., portions corresponding to particular events or times of interest).

In some implementations, the server system 206 transmits one or more streams 246 of video data to a client device 228 to facilitate event monitoring by a user. In some implementations, the one or more streams may include multiple streams, of respective resolutions and/or frame rates, of the same video feed. In some implementations, the multiple streams include a “primary” stream (e.g., 246-1) with a certain resolution and frame rate, corresponding to the video feed, and one or more additional streams (e.g., 246-2 through 246-t). An additional stream may be the same video stream as the “primary” stream but at a different resolution and/or frame rate, or a stream that shows a portion of the “primary” stream (e.g., cropped to include a portion of the field of view or pixels of the primary stream) at the same or different resolution and/or frame rate as the “primary” stream.

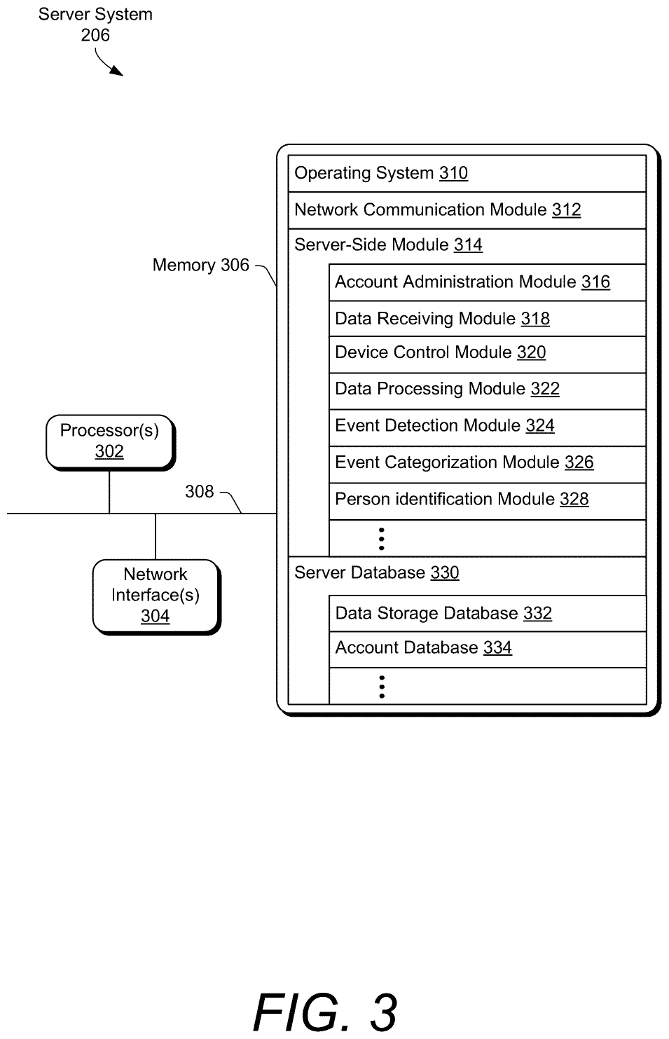

FIG. 3 is a block diagram illustrating the server system 206 in accordance with some implementations. The server system 206 typically includes one or more processors 302, one or more network interfaces 304 (e.g., including the I/O interface 240 to one or more client devices and the I/O interface 242 to one or more electronic devices), memory 306, and one or more communication buses 308 for interconnecting these components (sometimes called a chipset). The memory 306 includes high-speed random access memory, such as dynamic random access memory (DRAM), static random access memory (SRAM), double data rate synchronous dynamic random access memory (DDR SRAM), or other random access solid-state memory devices; and, optionally, includes non-volatile memory, such as one or more magnetic disk storage devices, one or more optical disk storage devices, one or more flash memory devices, or one or more other non-volatile solid-state storage devices. The memory 306, optionally, includes one or more storage devices remotely located from one or more of the processors 302. The memory 306, or alternatively the non-volatile memory within memory 306, includes a non-transitory computer-readable storage medium. In some implementations, the memory 306, or the non-transitory computer-readable storage medium of the memory 306, stores the following programs, modules, and data structures, or a subset or superset thereof:
an operating system 310 including procedures for handling various basic system services and for performing hardware dependent tasks;
a network communication module 312 for connecting the server system 206 to other systems and devices (e.g., client devices, electronic devices, and systems connected to one or more networks 108) via one or more network interfaces 304 (wired or wireless);
a server-side module 314, which provides server-side functionalities for device control, data processing, and data review, including, but not limited to:
   an account administration module 316 for creating reviewer accounts, performing camera registration processing to establish associations between video sources to their respective reviewer accounts, and providing account login services to the client devices 228;
   a data receiving module 318 for receiving data from electronic devices (e.g., video data from a video source 222 in FIG. 2B), and preparing the received data for further processing and storage in a data storage database (e.g., data storage database 332);
   a device control module 320 for generating and sending server-initiated control commands to modify operation modes of electronic devices (e.g., devices of a network environment 100), and/or receiving (e.g., from client devices 228) and forwarding user-initiated control commands to modify operation modes of the electronic devices;
   a data processing module 322 for processing the data provided by the electronic devices, and/or preparing and sending processed data to a device for review (e.g., client devices 228 for review by a user;
   an event detection module 324 for detecting motion event candidates in video streams from each of the video sources 222, including motion track identification, false positive suppression, and event mask generation and caching;
   an event categorization module 326 for categorizing motion events detected in received video streams; and
   a person identification module 328 for identifying characteristics associated with presence of humans in the received video streams; and
a server database 330, which provides server-side storage data associated with device control, data processing, and data review, including but not limited to:
   a data storage database 332 for storing data (e.g., raw/processed image data) associated with each electronic device (e.g., each video source 222) of each user account, as well as data processing models, processed data results, and other relevant metadata (e.g., names of data results, location of electronic device, creation time, duration, settings of the electronic device, etc.) associated with the data, where (optionally) all or a portion of the data and/or processing associated with the hub 176 or smart devices are stored securely; and
   an account database 334 for storing account information for user accounts, including user account information such as user profiles, information and settings for linked hub devices and electronic devices (e.g., hub device identifications), hub device-specific secrets, relevant user and hardware characteristics (e.g., service tier, device model, storage capacity, processing capabilities, etc.), user interface settings, data review preferences, etc., where the information for associated electronic devices includes, but is not limited to, one or more device identifiers (e.g., media access control (MAC) address and universal unique identifier (UUID)), device-specific secrets, and displayed titles.

Each of the above-identified elements may be stored in one or more of the previously mentioned memory devices and may correspond to a set of instructions for performing a function described above. The above-identified modules or programs (e.g., sets of instructions) need not be implemented as separate software programs, procedures, or modules, and thus various subsets of these modules may be combined or otherwise rearranged in various implementations. In some implementations, the memory 306, optionally, stores a subset of the modules and data structures identified above. Furthermore, the memory 306, optionally, stores additional modules and data structures not described above.

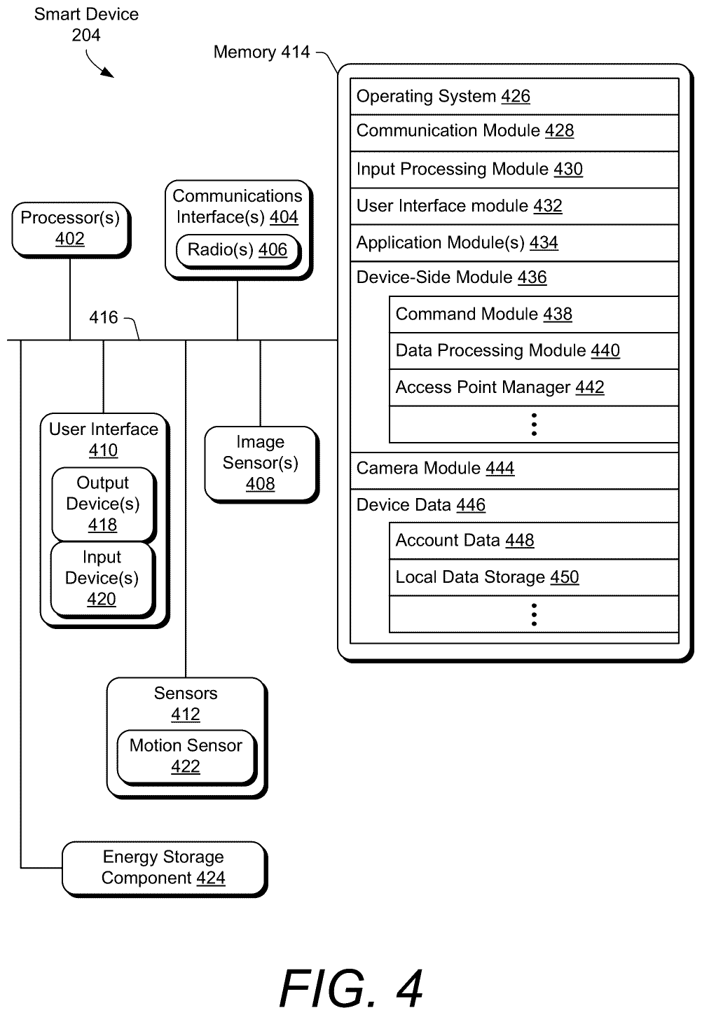

FIG. 4 is a block diagram illustrating an example smart device 204 in accordance with some implementations. In some implementations, the smart device 204 (e.g., any device of the network environment 100 in FIG. 1, including end user device 168, or of FIG. 2B, e.g., a doorbell 226) includes one or more processors 402 (e.g., central processing units (CPUs), application-specific integrated circuits (ASICs), field programmable gate arrays (FPGAs), microprocessors, and the like), one or more communication interfaces 404 with radios 406, image sensor(s) 408, user interfaces(s) 410, sensor(s) 412, memory 414, and one or more communication buses 416 for interconnecting these components (sometimes called a chipset). In some implementations, the user interface 410 includes one or more output devices 418 that enable presentation of media content, including one or more speakers and/or one or more visual displays. In some implementations, the user interface 410 includes one or more input devices 420, including user interface components that facilitate user input such as a keyboard, a mouse, a voice-command input unit or microphone, a touch screen display, a touch-sensitive input pad, a gesture capturing camera, or other input buttons or controls. In some implementations, an input device 420 for a doorbell 226 is a tactile or touch-sensitive doorbell button. Furthermore, some smart devices 204 use a microphone and voice recognition or a camera and gesture recognition to supplement or replace the keyboard.

The sensor(s) 422 include, for example, one or more thermal radiation sensors, ambient temperature sensors, humidity sensors, IR sensors such as PIR sensors, proximity sensors, range sensors, occupancy sensors (e.g., using RFID sensors), ambient light sensors (ALS), motion sensors 422, location sensors (e.g., Global navigation satellite systems (GNSS) sensors, global positioning satellite (GPS) sensors), accelerometers, and/or gyroscopes.

In some implementations, the smart device 204 includes an energy storage component 424 (e.g., one or more batteries and/or capacitors). In some implementations, the energy storage component 424 includes a power management integrated circuit (IC). In some implementations, the energy storage component 424 includes circuitry to harvest energy from signals received via an antenna (e.g., the radios 406) of the smart device. In some implementations, the energy storage component 424 includes circuitry to harvest thermal, vibrational, electromagnetic, and/or solar energy received by the smart device. In some implementations, the energy storage component 424 includes circuitry to monitor a stored energy level and adjust operation and/or generate notifications based on changes to the stored energy level.

The communication interfaces 404 include, for example, hardware capable of data communications using any of a variety of custom or standard wireless protocols (e.g., WLAN (in addition to Wi-Fi, IEEE 802.11 (including 802.11ax), and WiFi), low-rate wireless personal area network (LR-WPAN) (in addition to Bluetooth, Bluetooth low energy (BLE), IEEE 802.15.1, ZigBee, IEEE 802.15.4, wireless infrared communications, IrDA, Wireless USB, NFC, 6LoWPAN, Thread, Z-Wave, Bluetooth Smart, ISA100.5A, WirelessHART, MiWi, etc.), and wireless wide area network (WWAN) (in addition to Cellular, 5G, Long-Term Evolution (LTE), 4G, 3G, 2G, WiMAX, and IEEE 802.16)) and/or any of a variety of custom or standard wired protocols (e.g., Ethernet, HomePlug, etc.), or any other suitable communication protocol, including communication protocols not yet developed as of the filing date of this document. The radios 406 enable one or more radio communication networks in the network environments 100, and enable a smart device 204 to communicate with other devices. In some implementations, the radios 406 are capable of data communications using any of a variety of custom or standard wireless protocols (e.g., IEEE 802.11, IEEE 802.15.4, Wi-Fi, ZigBee, 6LoWPAN, Thread, Z-Wave, Bluetooth Smart, ISA100.5A, WirelessHART, MiWi, etc.).

The memory 414 includes high-speed random access memory, such as DRAM, SRAM, DDR RAM, or other random access solid-state memory devices; and, optionally, includes non-volatile memory, such as one or more magnetic disk storage devices, one or more optical disk storage devices, one or more flash memory devices, or one or more other non-volatile solid state storage devices. The memory 414, or alternatively the non-volatile memory within the memory 414, includes a non-transitory computer-readable storage medium. In some implementations, the memory 414, or the non-transitory computer-readable storage medium of the memory 414, stores the following programs, modules, and data structures, or a subset or superset thereof:
operating system 426 including procedures for handling various basic system services and for performing hardware dependent tasks;
a communication module 428 for coupling to and communicating with other network devices (e.g., a network interface 208, such as a router that provides Internet connectivity, networked storage devices, network routing devices, a server system 206, other smart devices 204, client devices 228, etc.) connected to one or more networks 108 via one or more communication interfaces 404 (wired or wireless);
an input processing module 430 for detecting one or more user inputs or interactions from the one or more input devices 420 and interpreting the detected inputs or interactions;
a user interface module 432 for providing and presenting a user interface in which settings, captured data, and/or other data for one or more devices (e.g., the smart device 204, and/or other devices in a network environment 100) can be configured and/or viewed;
one or more applications 434 for execution by the smart device (e.g., games, social network applications, smart home applications, and/or other web or non-web based applications) for controlling devices (e.g., executing commands, sending commands, and/or configuring settings of the smart device 204 and/or other client/electronic devices), and for reviewing data captured by devices (e.g., device status and settings, captured data, or other information regarding the smart device 204 and/or other client/electronic devices);
a device-side module 436, which provides device-side functionalities for device control, data processing and data review, including but not limited to:
   a command module 438 for receiving, forwarding, and/or executing instructions and control commands (e.g., from a client device 228, from a server system 206, from user inputs detected on the user interface 410, etc.) for operating the smart device 204;
   a data processing module 440 for processing data captured or received by one or more inputs (e.g., input devices 420, image sensor(s) 408, sensors 412, interfaces (e.g., communication interfaces 404, radios 406), and/or other components of the smart device 204, and for preparing and sending processed data to a remote device (e.g., client devices 228) for review by a user; and
   an access point manager 442 for performing access point, node, and router functionalities and providing Internet connectivity for one or more devices (wireless network device 204) connected to one or more networks 108 via one or more communication interfaces 404;
a camera module 444 for operating the image sensor(s) 408 and associated circuitry, e.g., for enabling and disabling the image sensor(s) 408 based on data from one or more low-power sensors 412 (e.g., data from a PIR sensor or ALS) and for adjusting encoding of raw image data captured by the image sensor(s) 408 (e.g., adjusting format, resolution, and/or framerate);
device data 446 storing data associated with devices (e.g., the smart device 204), including, but is not limited to:
   account data 448 storing information related to user accounts linked to the smart device 204, e.g., including cached login credentials, smart device identifiers (e.g., MAC addresses and UUIDs), user interface settings, display preferences, authentication tokens and tags, password keys, and the like; and
   local data storage 450 for selectively storing raw or processed data associated with the smart device 204, such as event data and/or video data captured by the image sensor(s) 408.

Each of the above-identified elements may be stored in one or more of the previously mentioned memory devices and correspond to a set of instructions for performing a function described above. The above-identified modules or programs (e.g., sets of instructions) need not be implemented as separate software programs, procedures, or modules, and thus various subsets of these modules may be combined or otherwise rearranged in various implementations. In some implementations, the memory 414, optionally, stores a subset of the modules and data structures identified above. Furthermore, the memory 414, optionally, stores additional modules and data structures not described above, such as a sensor management module for managing operation of the sensor(s) 412.

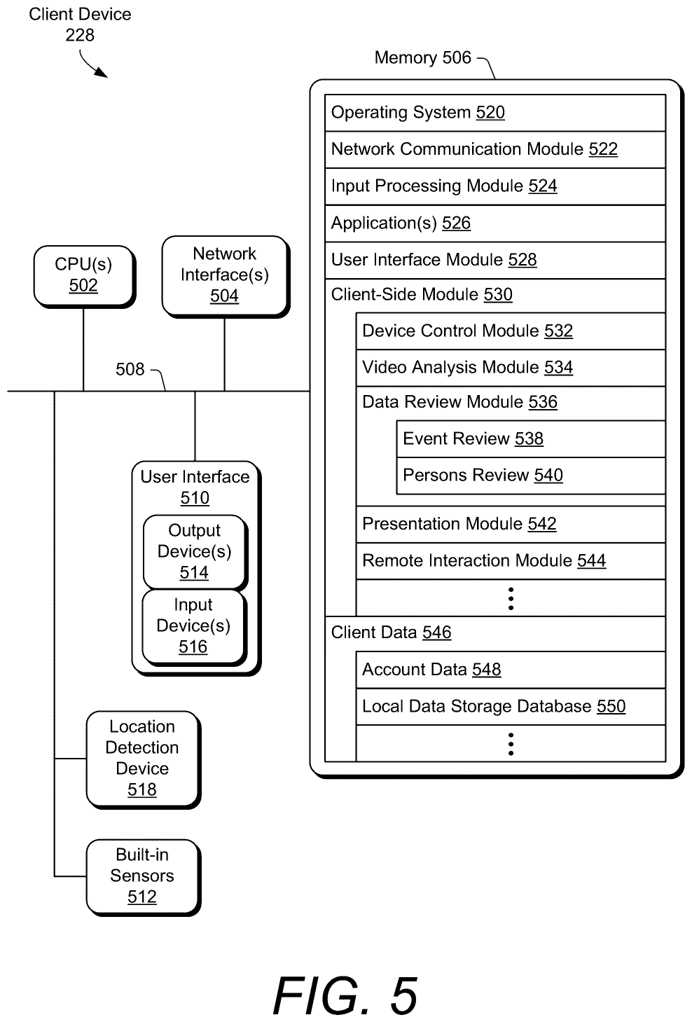

FIG. 5 is a block diagram illustrating a representative client device 228 associated with a user account in accordance with some implementations. The client device 228, typically, includes one or more processing units (CPUs) 502, one or more network interfaces 504, memory 506, and one or more communication buses 508 for interconnecting these components (sometimes called a chipset). Optionally, the client device also includes a user interface 510 and one or more built-in sensors 512 (e.g., accelerometer and gyroscope). The user interface 510 includes one or more output devices 514 that enable presentation of media content, including one or more speakers and/or one or more visual displays. The user interface 510 also includes one or more input devices 516, including user interface components that facilitate user input such as a keyboard, a mouse, a voice-command input unit or microphone, a touch screen display, a touch-sensitive input pad, a gesture capturing camera, or other input buttons or controls. Furthermore, some of the client devices use a microphone and voice recognition or a camera and gesture recognition to supplement or replace the keyboard. In some implementations, the client device includes one or more cameras, scanners, or photo sensor units for capturing images (not shown). Optionally, the client device includes a location detection device 518, such as a GPS sensor or other geo-location receiver, for determining the location of the client device.

The memory 506 includes high-speed random access memory, such as DRAM, SRAM, DDR SRAM, or other random access solid-state memory devices; and, optionally, includes non-volatile memory, such as one or more magnetic disk storage devices, one or more optical disk storage devices, one or more flash memory devices, or one or more other non-volatile solid state storage devices. The memory 506, optionally, includes one or more storage devices remotely located from one or more processing units 502. The memory 506, or alternatively the non-volatile memory within the memory 506, includes a non-transitory computer-readable storage medium. In some implementations, the memory 506, or the non-transitory computer-readable storage medium of the memory 506, stores the following programs, modules, and data structures, or a subset or superset thereof:
an operating system 520 including procedures for handling various basic system services and for performing hardware dependent tasks;
a network communication module 522 for connecting the client device 228 to other systems and devices (e.g., client devices, electronic devices, and systems connected to one or more networks 108) via one or more network interfaces 504 (wired or wireless);
an input processing module 524 for detecting one or more user inputs or interactions from one of the one or more input devices 516 and interpreting the detected input or interaction;
one or more applications 526 for execution by the client device (e.g., games, social network applications, smart home applications, and/or other web or non-web based applications) for controlling devices (e.g., sending commands, configuring settings, etc. to hub devices and/or other client or electronic devices) and for reviewing data captured by the devices (e.g., device status and settings, captured data, or other information regarding the hub device or other connected devices);
a user interface module 528 for providing and displaying a user interface in which settings, captured data, and/or other data for one or more devices (e.g., smart devices 204 in network environment 100) can be configured and/or viewed;
a client-side module 530, which provides client-side functionalities for device control, data processing and data review, including but not limited to:
   a device control module 532 for generating control commands for modifying an operating mode of smart devices (and optionally other electronic devices) in accordance with user inputs;
   a video analysis module 534 for analyzing captured video data, e.g., to detect and/or recognize persons, objects, animals, and events;
   a data review module 536 for providing user interfaces for reviewing data from the server system 206 or video sources 222, including but not limited to:
      an event review module 538 for reviewing events (e.g., motion and/or audio events), and optionally enabling user edits and/or updates to the events; and
      a person's review module 540 for reviewing data and/or images regarding detected persons and other entities, and optionally enabling user edits and/or updates to the persons data;
   a presentation module 542 for presenting user interfaces and response options for interacting with the smart devices 204 and/or the server system 206; and
   a remote interaction module 544 for interacting with a remote person (e.g., a visitor to the network environment 100), e.g., via a smart device 204 and/or the server system 206; and
client data 546 storing data associated with the user account and electronic devices, including, but not limited to:
   account data 548 storing information related to both user accounts loaded on the client device and electronic devices (e.g., of the video sources 222) associated with the user accounts, wherein such information includes cached login credentials, hub device identifiers (e.g., MAC addresses and UUIDs), electronic device identifiers (e.g., MAC addresses and UUIDs), user interface settings, display preferences, authentication tokens and tags, password keys, etc.; and
   a local data storage database 550 for selectively storing raw or processed data associated with electronic devices (e.g., of the video sources 222, such as a doorbell 226), optionally including entity data described previously.

Each of the above-identified elements may be stored in one or more of the previously mentioned memory devices and may correspond to a set of instructions for performing a function described above. The above-identified modules or programs (e.g., sets of instructions) need not be implemented as separate software programs, procedures, modules, or data structures, and thus various subsets of these modules may be combined or otherwise rearranged in various implementations. In some implementations, the memory 506, optionally, stores a subset of the modules and data structures identified above. Furthermore, the memory 506, optionally, stores additional modules and data structures not described above.

These and other capabilities and configurations, as well as ways in which entities of FIG. 1A through 5 act and interact, are set forth in greater detail below. The entities described with respect to FIG. 1A through FIG. 5 may be further divided, combined, and so on. The environment 100 of FIG. 1A, the environment 130 of FIG. 1B, and the detailed illustrations of FIG. 2A through FIG. 11D illustrate some of many possible environments, devices, and methods capable of employing the described techniques, whether individually or in combination with one another.

### Example Implementations

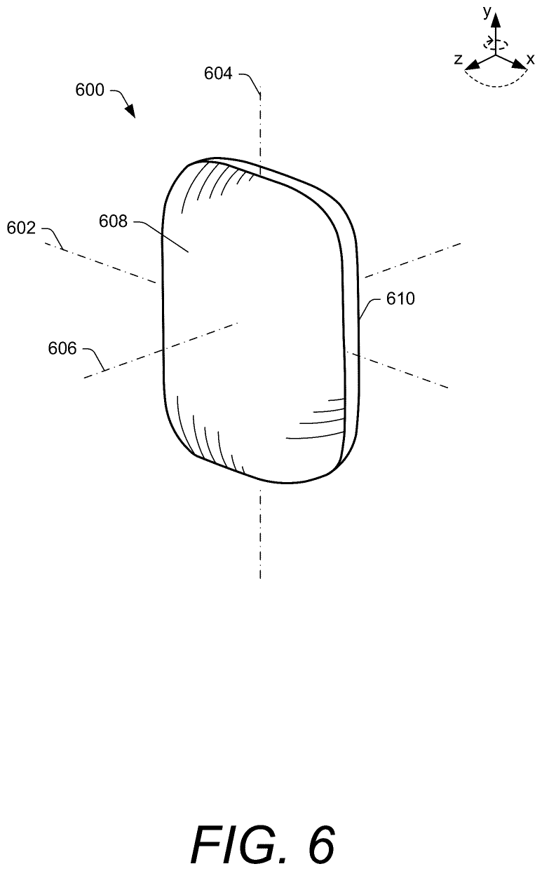

FIG. 6 illustrates an example device 600 (e.g., smart device 204, wireless network device 102, home router, border router 106, access point 110) for Wi-Fi 6E in accordance with some implementations. As illustrated in FIG. 6, the device 600 is shown with respect to an x-axis 602, a y-axis 604, and a z-axis 606. The x-axis 602 represents a width of the device 600, the y-axis 604 represents a height of the device 600, and the z-axis 606 represents a depth (e.g., front to rear) of the device 600. The device 600 includes a housing having a first housing component (e.g., front housing component 608) and a second housing component (e.g., rear housing component 610). The front and rear housing components 608 and 610 mate along a perimeter of each housing component along an xy-plane defined by the x-axis 602 and the y-axis 604. In some aspects, a seam formed between the front and rear housing components 608 and 610 is centered along the z-axis 606 so as to be substantially equidistant between a front exterior surface of the front housing component 608 and a rear exterior surface of the rear housing component 610. However, the seam may be formed between the front and rear housing components 608 and 610 at any suitable point along the depth (z-axis 606) of the device 600. In some implementations, the front and rear housing components 608 and 610 may be formed to mate along a different plane (e.g., the xz-plane defined by the x-axis 602 and the z-axis 606, the yz-plane defined by the y-axis 604 and the z-axis 606).

In implementations, the height of housing of the device 600 is greater than the width and the width is greater than the depth. In an example, the height may be in a range of approximately 100 mm to 150 mm (including approximately 116 mm), the width may be in a range of approximately 80 mm to 110 mm, and the depth may be in a range of approximately 65 mm to 85 mm. The corners and edges are rounded to provide a smooth transition between surfaces (e.g., front surface, side surface(s), top surface, rear surface, bottom surface). The housing forms an enclosure around the various components of the device 600. Accordingly, the device 600 has a form factor that appears to be an upright rectangular cuboid with rounded corners and edges. Because there is no speaker in the device 600, the housing lacks holes that would otherwise be implemented for the passage of soundwaves. Rather, the housing may be a solid, contiguous piece of injection-molded plastic, which is transparent to wireless signals in at least three frequency bands including 2.4 GHz, 5 GHz, and 6 GHz.

The device 600 may be used as a hub (e.g., hub 120) and/or may be used as an access point (e.g., access point 110) in a mesh network (e.g., home area network 202). The device 600 may operate as a router (e.g., mesh router), including a Wi-Fi 6E router, which means the device 600 meets IEEE standards for operating in the 6 GHz frequency band in addition to the 2.4 GHz and 5 GHz bands. Accordingly, the device 600 includes at least three frequency bands (e.g., 2.4 GHz, 5 GHz, and 6 GHz).

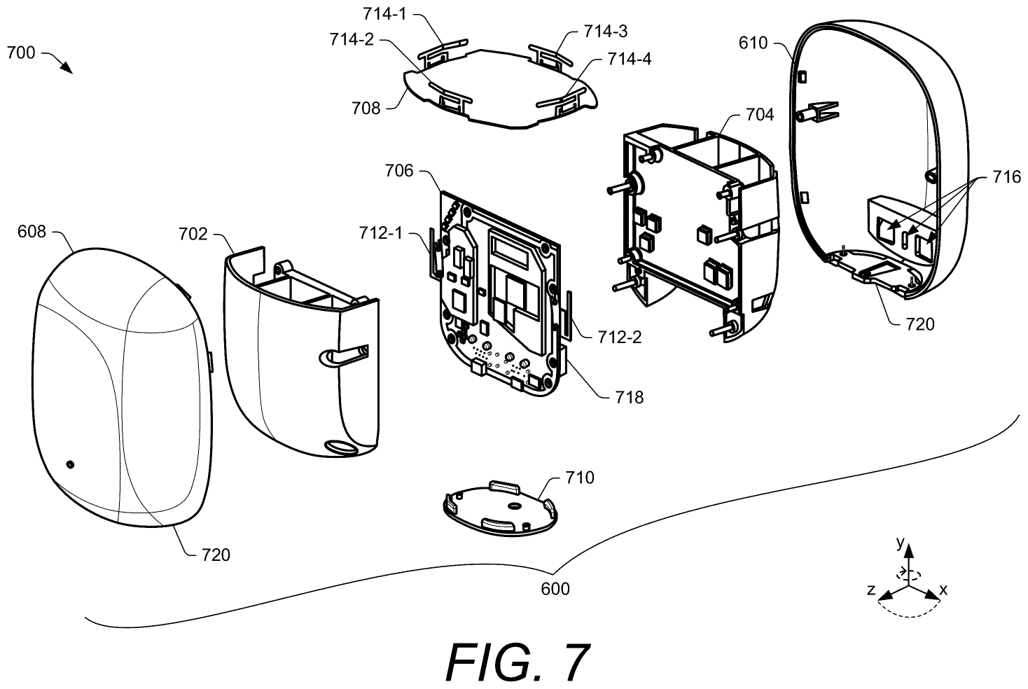

FIG. 7 illustrates an exploded view 700 of the example device in FIG. 6. The device 600 includes the front housing component 608 and the rear housing component 610, which form an enclosure. Inside the enclosure are a front heat sink 702 and a rear heat sink 704 on opposing sides of a printed circuit board (PCB) assembly (e.g., circuit board assembly 706). An example of the circuit board assembly 706 is a main logic board (MLB). Also included within the enclosure is an antenna plate 708. A baseplate 710 is attached to the exterior (e.g., bottom surface) of the housing to provide friction against a surface upon which the device 600 rests.

Notice that the circuit board assembly 706 is supported in a vertical orientation (e.g., in the xy-plane). Due to space constraints in the small form factor of the device 600, the circuit board assembly 706 is oriented vertically in the assembly.

The device 600 includes an antenna system enclosed within the housing and operable in at least three bands (e.g., 2.4 GHz, 5 GHz, and 6 GHz). The antenna system is illustrated as including orthogonal antenna placement, resulting in orthogonal current distributions that can enhance antenna isolation because both conducted currents and radiated near fields between perpendicular antennas couple together less than if the antennas were colinear. In an example, the circuit board assembly 706 includes one or more antennas 712 (e.g., antenna 712-1, antenna 712-2). In some implementations, the circuit board assembly 706 includes at least two antennas (e.g., antenna 712-1 and antenna 712-2). In an example, the antenna(s) 712 is attached to the circuit board assembly 706 via surface mount technology (SMT). Further, the antennas 712-1 and 712-2 extend outwardly from opposing sides of the circuit board assembly 706 in a plane (e.g., xy-plane) defined by the circuit board assembly 706 itself such that the antennas 712-1 and 712-2 are coplanar with the circuit board assembly 706. In aspects, the antennas 712-1 and 712-2 are inverted-F antennas and are configured for 2.4 GHz and 6 GHz wireless frequency bands.

The antenna plate 708 includes multiple antennas 714 (e.g., 714-1, 714-2, 714-3, 714-4), which are orthogonally placed relative to one another for enhanced coverage in the 5 GHz frequency band. For example, the antennas 714 form a 5 GHz wireless network system, which includes both primary and diversity antenna switching, along with Thread® and Bluetooth® technologies. The antenna plate 708 is a single plate with the antennas 714 formed into it. Accordingly, in some aspects, the antenna plate 708 is a single (one) piece of sheet metal with the antennas 714 stamped and bent to be above the ground plane, where the ground plane is defined by the metal plate (e.g., xz-plane).

Accordingly, the antenna topology for the device 600 is a tri-axis orthogonal antenna system that tends to direct current flow in orthogonal directions from each other, which can enhance antenna isolation. This architecture enables simultaneous transmission on the different frequency bands (e.g., 2.4 GHz, 5 GHz, and 6 GHz).

In implementations, the rear housing component 610 has one or more openings 716 that align with various ports on the circuit board assembly 706 positioned within the housing. Example ports include Ethernet ports (e.g., Ethernet port 718) and an electrical power connector (e.g., USB-C). The openings 716 are located in a portion (e.g., recessed area of the rear exterior surface) of the rear housing component 610 that is substantially parallel to the y-axis 604 such that an angle between the y-axis 604 and the portion of the rear housing component 610 is less than approximately five degrees. In some aspects, the portion (e.g., recessed area of the rear exterior surface) of the rear housing component 610 is substantially parallel to the xy-plane. The openings are also located proximate to (e.g. within 20 millimeters) a base 720 of the rear housing component 610. Because the circuit board assembly 706 is supported in a vertical orientation within the housing, the Ethernet port 718 and/or the electrical power connector may be mounted to the circuit board assembly 706 such that their mating direction is substantially orthogonal to the surface of the circuit board assembly 706. In this example, the Ethernet port 718 and/or the electrical power connector are mounted to have a mating direction that is orthogonal to the xy-plane (e.g., the mating direction is parallel to the z-axis 606).

The baseplate 710 may be attached or affixed to the base 720 of the rear housing component 610 and also to a base 722 of the front housing component 608. In some implementations, the baseplate 710 may be assembled to the front and rear housing components 608 and 610 via adhesive (e.g., pressure sensitive adhesive (PSA)), fasteners (e.g., screws, bolts), interlocking components (e.g., snap-fit, twist fitting), and so forth, or any combination thereof.

FIG. 8 illustrates some components of the device 600 from FIG. 7, including a circuit board assembly (e.g., circuit board assembly 706) and multiple heat sinks (e.g., heat sinks 702 and 704). The front heat sink 702 and the rear heat sink 704 each have a first surface (e.g., outer surface 802) opposite a second surface (e.g., inner surface 804). For example, the front heat sink 702 includes outer surface 802-1 and inner surface 804-1. The rear heat sink 704 includes outer surface 802-2 and inner surface 804-2. Both outer and inner surfaces 802 and 804 are exterior surfaces of the heat sinks 702 and 704. The inner surface 804 of each of the front and rear heat sinks 702 and 704 contacts the circuit board assembly 706 to conduct heat away from heat-dissipating components (e.g., integrated circuits) on the circuit board assembly 706. The outer surface 802 of each of the front and rear heat sinks 702 and 704 radiate the heat toward the front and rear housing components 608 and 610, respectively. The outer surface 802-1 of the front heat sink 702 conformingly corresponds to (e.g., follows the geometry of) an interior surface of the front housing component 608 to provide a large surface area contacting the front housing component 608 for transferring heat to the front housing component 608. Similarly, the outer surface 802-2 of the rear heat sink 704 conformingly corresponds to (e.g., follows the geometry of) an interior surface of the rear housing component 610 for transferring heat to the rear housing component 610. Further, front and rear heat sinks 702 and 704 have a y-axis dimension (e.g., height) that is in a range of 50% to 90% (e.g., 55% to 70%, 60% to 80%, 65% to 75%, 70% to 85%) of the height of the front and rear housing components 608 and 610.

Generally, the circuit board assembly 706 has various electrical components, including inadvertent noise sources that can radiate and be coupled into the antennas 712 and 714. The effect is to desensitize the receiver and thus decrease the maximum range of the antennas 712 and 714. To reduce the noise and the desensitization, the front heat sink 702 and the rear heat sink 704 assemble to one another with the PCB assembly in the middle (e.g., between the front and rear heat sinks 702 and 704). Because the surfaces of the heat sinks 702 and 704 are metal, the heat sinks 702 and 704 act as a noise suppression device by shielding the antennas from the potential noise sources that are active on the circuit board assembly 706.

The front heat sink 702 and the rear heat sink 704 each form a cavity (e.g., the front heat sink 702 forms a cavity 806, the rear heat sink 704 forms a cavity 808). These cavities 806 and 808 are formed to reduce weight and material costs in the heat sinks while maintaining heat conduction capabilities and providing structural integrity to the entire device 600.

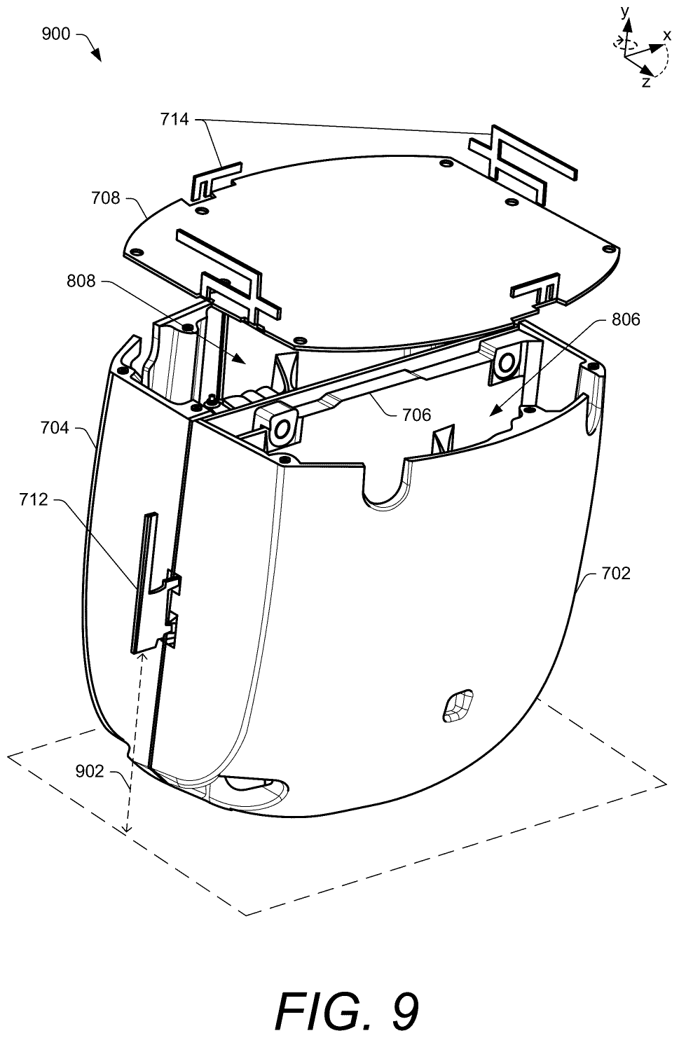

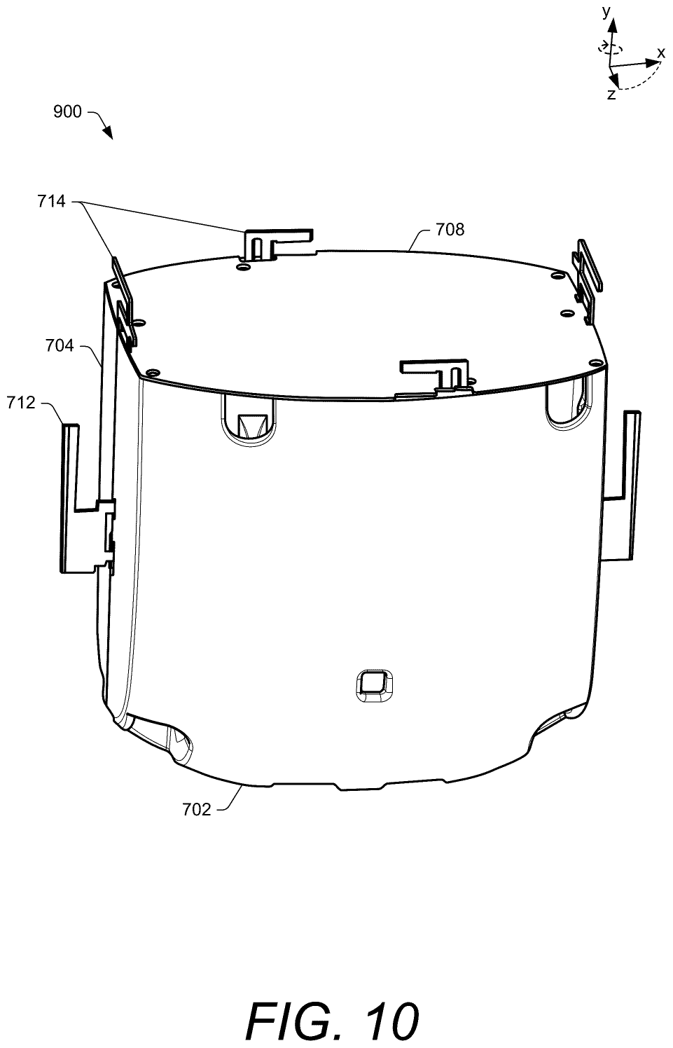

FIGS. 9 and 10 illustrate an antenna-and-shielding subassembly 900 of the device 600 from FIG. 7. In particular, FIG. 9 illustrates a front left perspective view of a partially assembled version of the antenna-and-shielding subassembly 900 of the device 600 from FIG. 7. FIG. 10 illustrates an example implementation of a fully assembled version of the antenna-and-shielding subassembly 900 from FIG. 9.

In FIG. 9, the front and rear heat sinks 702 and 704 are assembled together on opposing sides of the circuit board assembly 706 such that the front and rear heat sinks 702 and 704 form mating clamshells that sandwich the circuit board assembly 706 between them. The antennas 712 extend outwardly from the heat sinks 702 and 704, such that the heat sinks 702 and 704 do not cover or enclose the antennas 712. Further, the antennas 712 are each offset by a distance 902 of approximately one quarter lambda (λ/4) from the bottom of the device 600, which mitigates impacts from metal surfaces that can de-tune the antenna 712 and/or lossy surfaces that can potentially result in a lower range. Because the heat sinks 702 and 704 form one contiguous piece of metal surrounding the circuit board assembly 706, the heat sinks 702 and 704 help suppress unwanted noise that may radiate outwardly from the circuit board assembly 706 toward the antennas 712 (and antennas 714), which could desensitize the circuitry. In aspects, the heat sinks 702 and 704 directly contact the circuit board assembly 706. For example, the heat sinks 702 and 704 physically contact (e.g., abut) a gold plating perimeter on the circuit board assembly 706 that surrounds (in at least two dimensions) one or more integrated circuit components on the circuit board assembly 706. This physical contact helps create a conductive contact, thus shielding the circuit board assembly 706.

The cavities 806 and 808 result in directional radiation patterns that aim directly to the top of the device 600 (e.g., in the positive direction of the y-axis) in the 5 GHz frequency band. Typically, this is an undesired consequence of the heat sink design because the radiation patterns converge to one direction of coverage, whereas the 5 GHz plus diversity scheme relies on radiation patterns that are unique and have dissimilar coverage. To mitigate the upward directional radiation patterns caused by the cavities 806 and 808, the antenna plate 708 is assembled to the top of the heat sinks to close the openings to the cavities 806 and 808. In implementations, the antenna plate 708 is a solid piece of metal with no holes in its central area. In this way, the antenna plate 708 prevents the cavities 806 and 808 from focusing the radiation patterns in the upward direction (e.g., positive direction of the z-axis) and thus, the radiation patterns are able to have dissimilar coverage in space. In some implementations, the antenna plate 708 may include one or more holes along its perimeter that are used for assembly to the heat sinks 702 and 704. For example, holes along the perimeter provide routes for fasteners (e.g., screws, bolts) to be inserted and used to affix the antenna plate 708 to the front and rear heat sinks 702 and 704. In some implementations, the antenna plate 708 may include one or more additional holes that are sufficiently small in size to minimize the effects of the upwardly focused radiation patterns caused by the cavities 806 and 808.

In FIG. 10, the front heat sink 702, the rear heat sink 704, the circuit board assembly 706, and the antenna plate 708 together form the antenna-and-shielding subassembly 900. The antenna-and-shielding subassembly 900 includes antennas 712 and 714 oriented in a tri-axis antenna system having three pairs of antennas oriented along orthogonal principle axes [x, y, z]. The antenna-and-shielding subassembly 900 also includes the heat sink cavities 806 and 808 (shown in FIGS. 8 and 9) covered by the antenna plate 708. Further, the front and rear heat sinks 702 and 704 act as a shielding device to shield the antennas 712 and 714 from electromagnetic interference (EMI) generated by electrical components on the circuit board assembly 706 (shown in FIGS. 7 to 9). The circuit board assembly 706 includes exposed copper (or other conductive material) that physically contacts the heat sinks 702 and 704 to complete the shielding. In aspects, exposed copper (or other conductive material) is disposed along the perimeter of the circuit board assembly 706 on a first side that interfaces with the front heat sink 702 such that the exposed copper contacts the front heat sink 702. In addition, exposed copper (or other conductive material) is disposed along the perimeter of the circuit board assembly 706 on a second side (opposite the first side) that interfaces with the rear heat sink 702 such that the exposed copper contacts the rear heat sink 702. To further complete the shielding, the antenna plate 708 is fastened (e.g., screwed) to the front and rear heat sinks 702 and 704 to form a shield around the top (positive direction of y-axis) of the circuit board assembly 706. The antenna-and-shielding subassembly 900 also maintains at least a one quarter wavelength height, from a surface (e.g., wood, metal, plastic, granite, ceramic) that the device 600 rests on, for the 2.4 GHz antennas (e.g., antennas 712) to minimize effects from the surface.

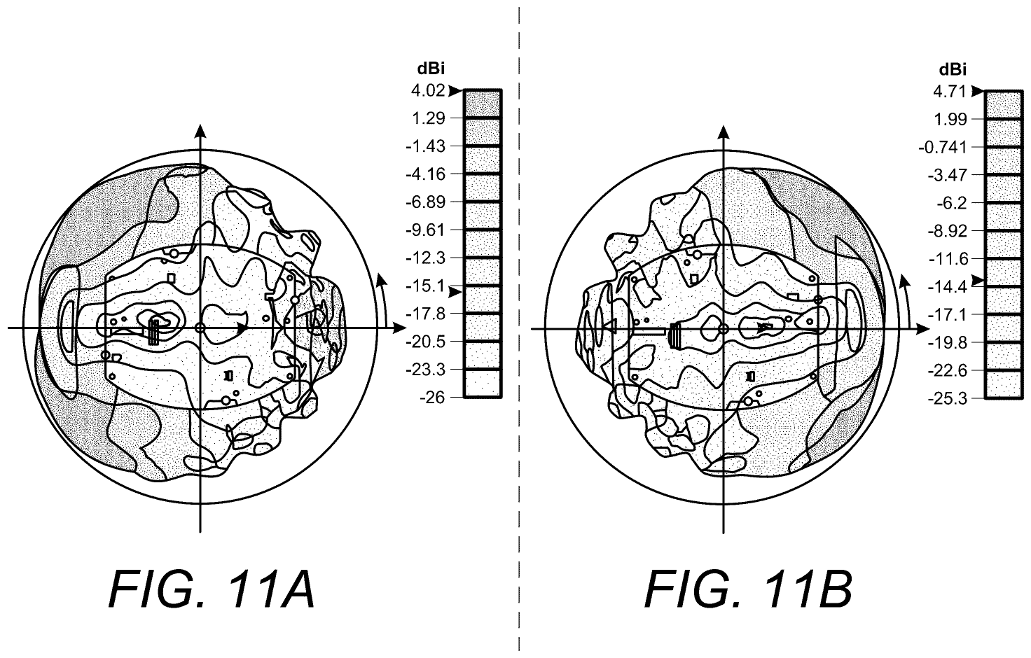

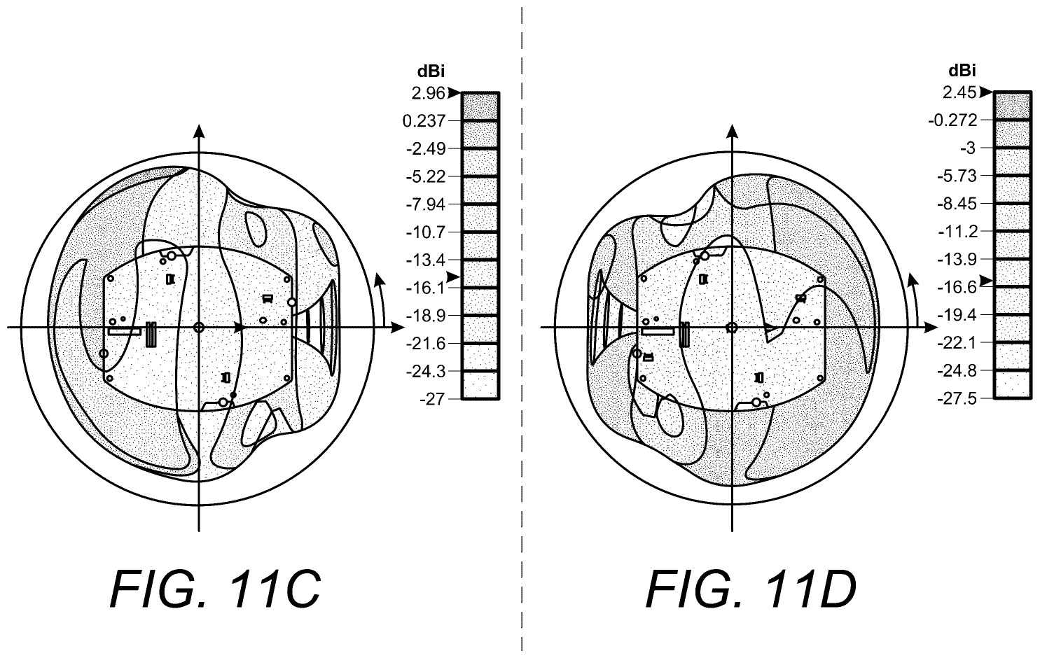

FIGS. 11A to 11D illustrate example radiation patterns of the antennas 712 (e.g., 2.4 GHz and 6 GHz antennas) from FIG. 7, in accordance with one or more implementations. Antennas in close proximity tend to have high correlation, which reduces the effectiveness of multiple input, multiple output (MIMO) antennas. The antennas 712 tend to have radiation patterns that are opposite in pattern to the other within the same frequency band. The correlation can be defined as ρₑₙᵥ by the following:

$$Equation 1$$

$$ρ\_env = \frac{{\vert ∮ \{ XPR * {E}_{θ 1} ( Ω ) {E}_{θ 2}^{*} ( Ω ) {P}_{θ} ( Ω ) + {E}_{ϕ 1} ( Ω ) {E}_{ϕ 2}^{*} ( Ω ) {P}_{ϕ} ( Ω ) \} d Ω \vert}^{2}}{\begin{matrix}∮ \{ XPR * {E}_{θ 1} ( Ω ) {E}_{θ 1}^{*} ( Ω ) {P}_{θ} ( Ω ) + {E}_{ϕ 1} ( Ω ) {E}_{ϕ 1}^{*} ( Ω ) {P}_{ϕ} ( Ω ) \} d Ω * \\ ∮ \{ XPR * {E}_{θ 2} ( Ω ) {E}_{θ 2}^{*} ( Ω ) {P}_{θ} ( Ω ) + {E}_{ϕ 2} ( Ω ) {E}_{ϕ 2}^{*} ( Ω ) {P}_{ϕ} ( Ω ) \} d Ω\end{matrix}}$$

In Equation 1, the term XPR is the cross discrimination ratio between vertical and horizontal polarized power components. The terms E_{θ1}, E_{θ2}, E_{ϕ1}, and E_{ϕ2} are the electric field components of the first and second antennas (e.g., antennas 712-1 and 712-2) in elevation and azimuth directions, respectively. P_{θ} and P_{ϕ} are the elevational and azimuthal angular power spectrum (APS) distribution.

By minimizing the products E_{θ1}E*_{θ2} and E_{ϕ1}E*_{ϕ2}, the antennas become decorrelated (and polar opposites). This minimization is enhanced by having radiation patterns in opposite directions. For example, FIG. 11A represents the radiation pattern of the 6 GHz band of antenna 712-1 in FIG. 7 and FIG. 11B represents the radiation pattern of the 6 GHz band of antenna 712-2 in FIG. 7. As a comparison, the radiation pattern of antenna 712-2 in the 6 GHz band, as shown in FIG. 11B, is directed in an opposite direction relative to the radiation pattern of antenna 712-1 in the 6 GHz band, as shown in FIG. 11A.

Similarly, FIG. 11C represents the radiation pattern of the 2.4 GHz band of antenna 712-1 and FIG. 11D represents the radiation pattern of the 2.4 GHz band of antenna 712-2. As a comparison, the radiation pattern of antenna 712-2 in the 2.4 GHz band, as shown in FIG. 11D, is directed in an opposite direction relative to the radiation pattern of antenna 712-1 in the 2.4 GHz band, as shown in FIG. 11C.

Accordingly, the antennas 712-1 and 712-2 are decorrelated (in both the 2.4 GHz band and the 6 GHz band) based on a minimization of products of electrical fields generated by each of the antennas 712-1 and 712-2 and based on radiation patterns of the antennas 712-1 and 712-2 being directed in opposite directions relative to one another.

Some examples are described below:

Example 1: A wireless network device comprising: a housing having a height along a y-axis, a width along an x-axis, and a depth along a z-axis, the height being greater than the width, the width being greater than the depth, the housing forming an upright rectangular cuboid with rounded corners and edges, the housing including a front housing component and a rear housing component that connect to each other along a perimeter of each of the front and rear housing components along an xy-plane defined by the x-axis and the y-axis; an antenna system enclosed within the housing and operable in at least three bands including 2.4 gigahertz, 5 gigahertz, and 6 gigahertz; and a circuit board assembly positioned within the housing and operable to provide at least one of a gateway or a node to a wireless network.

Example 2: The circuit board assembly of example 1 may be supported in an orientation parallel to the xy-plane.

Example 3: The wireless network device of example 1 or 2, wherein the circuit board assembly is thermally coupled, in particularly at least partially enclosed by at least one heat sink, in particular with an antenna-and shielding subassembly comprises the at least one heat sink.

Example 4: The circuit board assembly of at least one of the preceding examples, may be enclosed within an antenna-and-shielding subassembly comprising first and second heat sinks assembled together with the circuit board assembly therebetween to shield the antenna system from electromagnetic interference generated by electrical components on the circuit board assembly.

Example 5: The circuit board assembly of example 3 or 4 may include a first side and an opposing second side; the first heat sink may include: a first inner surface that physically contacts the first side of the circuit board assembly to conduct heat away from the first side of the circuit board assembly; and a first outer surface that conformingly corresponds to a first interior surface of the front housing component and contacts the first interior surface of the front housing component to transfer heat to the front housing component; and the second heat sink may include: a second inner surface that physically contacts the second side of the circuit board assembly to conduct heat away from the second side of the circuit board assembly; and a second outer surface that conformingly corresponds to a second interior surface of the rear housing component and contacts the second interior surface of the rear housing component to transfer heat to the rear housing component.

Example 6: The wireless network device of example 5, wherein the first and second heat sinks each define a cavity with an opening; and the antenna-and-shielding subassembly may include an antenna plate covering the opening of each cavity.

Example 7: The wireless network device of example 6, wherein the antenna system may include multiple antennas attached to the antenna plate and forming a 5 gigahertz wireless network system including both primary and diversity antenna switching.

Example 8: The wireless network device of example 7, wherein the antenna plate may be a single piece of sheet metal forming a ground plane; and the multiple antennas on the antenna plate may be stamped and bent to be above the ground plane.

Example 9: The wireless network device of any of the examples 3 to 8, wherein the antenna system may include at least two antennas attached to the circuit board assembly that extend outwardly from an edge of the circuit board assembly; the at least two antennas may be coplanar with the circuit board assembly; the at least two antennas may extend outwardly from the first and second heat sinks that surround the circuit board assembly; and the at least two antennas may be offset from a base of the wireless network device by approximately one quarter wavelength.

Example 10: The wireless network device of example 9, wherein the at least two antennas may be attached to the circuit board assembly via a surface mount technology.

Example 11: The wireless network device of example 9 or 10, wherein the at least two antennas may each be operable in both the 2.4 gigahertz band and the 6 gigahertz band.

Example 12: The wireless network device of any one of the examples 9 to 11, wherein the at least two antennas may be decorrelated based on a minimization of products of electrical fields generated by each of the at least two antennas and based on radiation patterns of the at least two antennas being directed in opposite directions relative to one another.

Example 13: The wireless network device of any of the examples 3 to 12, wherein the first and second heat sinks may have a y-axis dimension that is in a range of 50% to 90% of the height of the housing.

Example 14: The wireless network device of any of the preceding examples, wherein the rear housing component may include one or more openings that align with one or more ports on the circuit board assembly; and the one or more openings may be located in a portion of the rear housing component that is parallel to the xy-plane.

Example 15: The wireless network device of any of the preceding examples, wherein the one or more ports on the circuit board assembly may include an Ethernet port and an electrical power connector.

Example 16: The wireless network device of any of the preceding examples, wherein the antenna system may be a tri-axis orthogonal antenna system having three pairs of antennas oriented along orthogonal principle axes.

Example 17: The wireless network device of any of the preceding examples, wherein the wireless network device is configured as or comprises a thermostat, a hazard detector, a camera, a lighting unit, an entryway door lock system, a detector for an room occupancy state, an alarm system, a wearable computing device, a motion detector, a vibration detector and/or a doorbell.

### CONCLUSION

Although aspects of a wireless network device operable in the 6 GHz band have been described in language specific to features and/or methods, the subject of the appended claims is not necessarily limited to the specific features or methods described. Rather, the specific features and methods are disclosed as example implementations of the techniques for a wireless network device operable in the 6 GHz band, and other equivalent features and methods are intended to be within the scope of the appended claims. Further, various different aspects are described, and it is to be appreciated that each described aspect can be implemented independently or in connection with one or more other described aspects.

1. A wireless network device comprising:
a housing having a height along a y-axis, a width along an x-axis, and a depth along a z axis, the height being greater than the width, the width being greater than the depth, the housing forming an upright rectangular cuboid with rounded corners and edges, the housing including a front housing component and a rear housing component that connect to each other along a perimeter of each of the front and rear housing components along an xy-plane defined by the x axis and the y-axis;
an antenna system enclosed within the housing and operable in at least three frequency bands including 2.4 gigahertz, 5 gigahertz, and 6 gigahertz; and
a circuit board assembly positioned within the housing and operable to provide at least one of a gateway or a node to a wireless network.

2. The wireless network device of claim 1, wherein the circuit board assembly is supported in an orientation parallel to the xy-plane.

3. The wireless network device of claim 1, wherein:
the circuit board assembly is thermally coupled to an antenna-and-shielding subassembly comprising at least one heat sink; and
the circuit board assembly is partially enclosed by the at least one heat sink.

4. The wireless network device of claim 1, wherein the circuit board assembly is enclosed within an antenna-and-shielding subassembly comprising first and second heat sinks assembled together with the circuit board assembly therebetween to shield the antenna system from electromagnetic interference generated by electrical components on the circuit board assembly.

5. The wireless network device of claim 3, wherein:
the circuit board assembly includes a first side and an opposing second side;
the first heat sink includes:
a first inner surface that physically contacts the first side of the circuit board assembly to conduct heat away from the first side of the circuit board assembly; and
a first outer surface that conformingly corresponds to a first interior surface of the front housing component and contacts the first interior surface of the front housing component to transfer heat to the front housing component; and
the second heat sink includes:
a second inner surface that physically contacts the second side of the circuit board assembly to conduct heat away from the second side of the circuit board assembly; and
a second outer surface that conformingly corresponds to a second interior surface of the rear housing component and contacts the second interior surface of the rear housing component to transfer heat to the rear housing component.

6. The wireless network device of claim 5, wherein:
the first and second heat sinks each define a cavity with an opening; and
the antenna-and-shielding subassembly includes an antenna plate covering the opening of each cavity.

7. The wireless network device of claim 6, wherein the antenna system includes multiple antennas attached to the antenna plate and forming a 5 gigahertz wireless network system including both primary and diversity antenna switching.

8. The wireless network device of claim 7, wherein:
the antenna plate is a single piece of sheet metal forming a ground plane; and
the multiple antennas on the antenna plate are stamped and bent to be above the ground plane.

9. The wireless network device of claim 4, wherein:
the antenna system includes at least two antennas attached to the circuit board assembly that extend outwardly from an edge of the circuit board assembly;
the at least two antennas are coplanar with the circuit board assembly;
the at least two antennas extend outwardly from the first and second heat sinks that surround the circuit board assembly; and
the at least two antennas are offset from a base of the wireless network device by approximately one quarter wavelength.

10. The wireless network device of claim 9, wherein the at least two antennas are each operable in both the 2.4 gigahertz band and the 6 gigahertz band.

11. The wireless network device of claim 9, wherein the at least two antennas are decorrelated based on a minimization of products of electrical fields generated by each of the at least two antennas and based on radiation patterns of the at least two antennas being directed in opposite directions relative to one another.

12. The wireless network device of claim 4, wherein the first and second heat sinks have a y-axis dimension that is in a range of 50% to 90% of the height of the housing.

13. The wireless network device of claim 1, wherein:
the rear housing component includes one or more openings that align with one or more ports on the circuit board assembly; and
the one or more openings are located in a portion of the rear housing component that is parallel to the xy-plane.

14. The wireless network device of claim 13, wherein the one or more ports on the circuit board assembly include an Ethernet port and an electrical power connector.

15. The wireless network device of claim 1, wherein the antenna system is a tri-axis orthogonal antenna system having three pairs of antennas oriented along orthogonal principle axes.

16. The wireless network device of claim 1, wherein the wireless network device is configured as or comprises a thermostat, a hazard detector, a camera, a lighting unit, an entryway door lock system, a detector for a room occupancy state, an alarm system, a wearable computing device, a motion detector, a vibration detector, or a doorbell.

17. The wireless network device of claim 7, wherein:
the antenna system includes at least two antennas attached to the circuit board assembly that extend outwardly from an edge of the circuit board assembly;
the at least two antennas are coplanar with the circuit board assembly;
the at least two antennas extend outwardly from the first and second heat sinks that surround the circuit board assembly; and
the at least two antennas are offset from a base of the wireless network device by approximately one quarter wavelength.

18. The wireless network device of claim 17, wherein the at least two antennas are each operable in both the 2.4 gigahertz band and the 6 gigahertz band.

19. The wireless network device of claim 17, wherein the at least two antennas are decorrelated based on a minimization of products of electrical fields generated by each of the at least two antennas and based on radiation patterns of the at least two antennas being directed in opposite directions relative to one another.

20. The wireless network device of claim 17, wherein the first and second heat sinks have a y-axis dimension that is in a range of 50% to 90% of the height of the housing.
